(19) United States
(12) Patent Application Publication
(10) Pub. No.: US 2026/0057653 A1
(43) Pub. Date: Feb. 26, 2026

(54) COMPUTER-IMPLEMENTED PERCEPTION OF 2D OR 3D SCENES

(71) Applicant: Five AI Limited, Cambridge (GB)

(72) Inventors: Edward Ayers, Cambridge (GB); Jonathan Sadeghi, Cambridge (GB); John Redford, Cambridge (GB); Romain Muller, Cambridge (GB); Puneet Dokania, Cambridge (GB)

(73) Assignee: Five AI Limited, Cambridge (GB)

(21) Appl. No.: 18/998,957

(22) PCT Filed: Jul. 26, 2023
(86) PCT No.: PCT/EP2023/070770

§ 371 Date: Jan. 27, 2025

(30) Foreign Application Priority Data
Jul. 27, 2022 (GB) 2210981.3

(51) Int. Cl. G06V 10/776; G06V 10/764; G06V 10/774; G06V 10/98

(52) U.S. Cl. CPC G06V 10/776; G06V 10/764; G06V 10/7747; G06V 10/98

(57) ABSTRACT

A computer-implemented method of assessing performance of perception component, the perception component for interpreting structure in a scene comprises: receiving a set of multiple computed outputs obtained by applying the perception component to the scene, wherein each computed output comprises a confidence score: generating, from the set of multiple computed outputs, multiple pseudo-ground truth sets, wherein each pseudo-ground truth set comprises, for each computed output, a pseudo-ground truth output sampled from a set of possible ground truth outputs based on a probability distribution defined by the confidence score of the computed output; computing a performance score for the perception component applied to the scene with respect to each pseudo-ground truth set, by comparing the set of multiple outputs with that pseudo-ground truth set; and computing an overall performance score for the perception component applied to the scene, by aggregating the performance scores computed with respect to the multiple pseudo-ground truth sets.

### TECHNICAL FIELD

The present disclosure pertains generally to object detection, and in particular to tools and techniques to support the development, testing and/or validation of perception components such as object detectors. Such tools/techniques may be used to identify and mitigate performance issues in object detectors applied to 2D or 3D scenes, such as 2D or 3D multi-object scenes.

### BACKGROUND

Machine learning (ML)-based perception of 2D or 3D structure in scenes is considered herein. Computer vision considers scenes in the form of images. Herein, perception refers more broadly to the perception of structure in images and/or other types of scene. Perception can encompass one or multiple sensor modalities, such as image, lidar, radar etc., or any combination thereof.

A scene may be 2D or 3D. A scene can be an image, but the present techniques can be applied to other modalities, such as lidar, radar etc. and/or other scene data representations such as points clouds, voxel encodings, surface meshes etc. An object detection may for example be a 2D or 3D bounding box or other bounding object (and may or may not include an object classification). A scene may be captured substantially instantaneously, or the scene may be captured over a longer time interval (for example, a lidar or radar point cloud may be accumulated over time; pre-processing may or may not be applied to compensate for any object and/or sensor motion in that time interval).

In a machine learning (ML) context, a perception component may comprise one or more trained perception models. For example, machine vision processing is frequently implemented using convolutional neural networks (CNNs). Such networks are typically trained on large numbers of training images which have been annotated with information that the neural network is required to learn (a form of supervised learning). At training time, the network is presented with thousands, or preferably hundreds of thousands, of such annotated images and learns for itself how features captured in the images themselves relate to annotations associated therewith. This is a form of visual structure detection applied to images. Each image is annotated in the sense of being associated with annotation data. The image serves as a perception input, and the associated annotation data provides a “ground truth” (GT) for the image.

CNNs and other forms of perception model can be architected to receive and process other forms of perception inputs, such as point clouds, voxel tensors etc., and to perceive structure in 2D or 3D space. In the context of training generally, a perception input may be referred to as a “training example” or “training input”. By contrast, perception inputs captured for processing by a trained perception component at runtime may be referred to as “runtime inputs”. Annotation data associated with a training input provides a “ground truth” for that training input in that the annotation data encodes an intended perception output for that training input. In a supervised training process, parameters of a perception component are tuned systematically to minimize, to a defined extent, an overall measure of difference between the perception outputs generated by the perception component when applied to the training examples in a training set (the “actual” perception outputs) and the corresponding ground truths provided by the associated annotation data (the intended perception outputs). In this manner, the perception input “learns” from the training examples, and moreover is able to “generalize” that learning, in the sense of being able, once trained, to provide meaningful perception outputs for perception inputs it has not encountered during training. Similar metrics may be used to validate a trained perception component.

Such perception components are a cornerstone of many established and emerging technologies. For example, in the field of robotics, mobile robotic systems that can autonomously plan their paths in complex environments are becoming increasingly prevalent. An example of such a rapidly emerging technology is autonomous vehicles (AVs) that can navigate by themselves on urban roads. Such vehicles must not only perform complex maneuvers among people and other vehicles, but they must often do so while guaranteeing stringent constraints on the probability of adverse events occurring, such as collision with these other agents in the environments. In order for an AV to plan safely, it is crucial that it is able to observe its environment accurately and reliably. This includes the need for accurate and reliable detection of real-world structure in the vicinity of the vehicle. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

### SUMMARY

Perception performance metrics are a critical component of modern computer vision and ML-based perception. However, existing methods that utilize such metrics require high-quality ground truth as a benchmark for the analysis. For example, object detector performance on a given scene may be assessed in term of false negatives (or ‘missed’ detections), false positives (or ‘ghost’ detections), or overall false detections (both true positive and false positive). A false negative occurs when an object detector fails to detect an object that is present in the ground truth. A false positive detection occurs when an object detector detects a ‘ghost’ object that is not present in the ground truth. Other aspects of performance can be evaluated by comparing the output of a perception component with corresponding ground truth using some appropriate performance metric (e.g., error metric).

Evaluating perception in this manner requires high-quality ground truth, which in turn is typically obtained via manual annotation (requiring significant manual effort), or via expensive ‘offline’ processing (typically involving non-real time and/or non-causal perception algorithms) that require significant computational resources to run, or some combination of offline processing and manual annotation.

Herein, a novel methodology is described, which allows such metrics to be used to quantify the same aspect or aspects of perception performance but on ‘unannotated’ scenes without such ground truth. This enables perception performance to be assessed without the need to generate expensive perception ground truth as a baseline for the assessment.

A first aspect herein provides a computer-implemented method of assessing performance of perception component, the perception component for interpreting structure in a scene, the method comprising: receiving a set of multiple computed outputs obtained by applying the perception component to the scene, wherein each computed output comprises a confidence score; generating, from the set of multiple computed outputs, multiple pseudo-ground truth sets, wherein each pseudo-ground truth set comprises, for each computed output, a pseudo-ground truth output sampled from a set of possible ground truth outputs based on a probability distribution defined by the confidence score of the computed output; computing a performance score for the perception component applied to the scene with respect to each pseudo-ground truth set, by comparing the set of multiple outputs with that pseudo-ground truth set; and computing an overall performance score for the perception component applied to the scene, by aggregating the performance scores computed with respect to the multiple pseudo-ground truth sets.

Though a rigorous performance, perception performance can ultimately be improved. For example, the present techniques can be used to identify ‘hard’ scenes on which the perception component performs relatively poorly in the overall performance score. Those hard scenes indicate a performance issue with the perception component, which can now be mitigated. For example, those hard scenes can then be used as a basis for re-training or otherwise re-engineering the perception component e.g., by including those hard scenes and/or similarly hard scenes in an updated training set that is used to re-train the perception component. In identifying and mitigating performance issues using the method of the first aspect, a significant improvement in overall efficiency is achieved (in comparison to conventional methodologies used to test and refine perception components) because the identification of those hard scenes does not require expensive ground truth.

In generating the multiple pseudo-ground truth sets, each probability distribution (corresponding one of the actual computed outputs) is sampled multiple times, with possibly different outcomes, resulting in potentially different combinations of the possible ground truth outputs, against which the performance of the perception component is evaluated (resulting in possibly different performance scores across the set of pseudo-ground truth sets).

In embodiments, the perception component may be an object detector, and the set of multiple computed outputs may be a set of object detections obtained by applying the object detector to the scene, each object detection including a confidence score.

Each pseudo-ground truth object set may comprise, for each object detection, an existence indicator assigned thereto, wherein the existence indicator is sampled from a set of existence indicators based on a probability distribution defined by the confidence score of the object detection.

The existence indicators may be used in the comparison performed to compute the performance score for each pseudo-ground truth set.

For example, comparing the set of multiple outputs with that pseudo-ground truth set may comprise comparing the set of object detections with the pseudo-ground truth object set, to identify any discrepant object detections of the set of object detections, a discrepant object detection having: a positive existence indicator in the pseudo-ground truth object set and a confidence score that does not satisfy a minimum confidence threshold, or a negative existence indicator in the pseudo-ground truth object set and a confidence score that does satisfy the minimum confidence threshold. The performance score may be computed based on the discrepant object detections.

In such embodiments, the confidence score is interpreted as defining a probability that a ground truth object corresponding to the detection exists. An object detection that is assigned positive existence indicator in the pseudo-ground truth object set and a confidence score that does not satisfy a minimum confidence threshold implies the detection is classed as a ‘false negative’ with respect to that particular pseudo-ground truth object set (the corresponding groundtruth object does exist in that pseudo-ground truth set, but the confidence score is too low to trigger a ‘true’ detection). An object detection that is assigned a negative existence indicator in the pseudo-ground truth object set and a confidence score that does satisfy the minimum confidence threshold is classed as a ‘false positive’ with respect to that particular pseudo-ground truth object set (the corresponding groundtruth object does not exist in that pseudo-ground truth set, but the confidence score is high enough to trigger a ‘true’ detection).

An object detection that is classed discrepant with respect to one pseudo-ground truth object set will not necessarily be classed as discrepant with respect to another pseudo-ground truth object set. This is because different existence indicators may be assigned to the same object detection in different pseudo-ground truth sets (because the sampling from the probability distribution defined by its confidence score may have different outcomes). For example, an object detection with a confidence score above the minimum confidence threshold may be classed as a false positive with respect to a first pseudo-ground truth set (because it is assigned a negative existence indicator in the first pseudo-ground truth set) and as a true positive with respect to a second pseudo-ground truth set (because it is assigned a positive existence indicator in the second pseudo-ground truth set).

Perception “hardness” can be evaluated based on one or more of false positive detections, false negative detections, or false detections (false positives and false negatives combined). As noted, here, “falseness/trueness” is with respect to a particular pseudo-ground truth set (a detection may be classed as “false” with respect to one pseudo-ground truth set but “true” with respect to another because it is assigned different indicators in those sets, as a consequence of different sampling outcomes). In this context, false positive and false negative detections may be defined as set out in Table 1.

TABLE 1
concepts pertaining to i^{th} object detection
with respect to k^{th} pseudo-ground truth set.

| | Positive detection: | |
|---|---|---|
| | confidence score | Negative detection: |
| | (s_i) satisfies | confidence score does |
| | confidence | not satisfy |
| | threshold (t), | confidence threshold, |
| | e.g. s_i ≥ t | e.g. s_i < t |
| Positive existence | True positive (TP) | False negative (FN) |
| indicator | | |
| (X_i = 1) | | |
| Negative existence | False positive (FP) | True negative (TN) |
| indicator | | |
| (X_i = 0) | | |

It is an immaterial design choice as to whether a confidence score equal to the threshold is classed as positive or negative.

The set of object detections referred to above could include all (final) object detections outputted by the object detector; that is, both positive detections (above confidence threshold) and negative object detections (below confidence threshold). In this case, both false positives and false negatives (in the above sense) may be considered, in order to evaluate hardness with respect to false detections overall.

Alternatively, the set of object detections may be a subset of the overall detector output that includes only positive detections above the confidence threshold (e.g. for evaluating hardness on false positives only) or only negative detections below the confidence threshold (e.g. for evaluating hardness on false negatives only).

The method can also be applied to evaluate other aspects of performance within the framework of Table 1 (e.g., metric based on true positives, as discussed in further detail below).

For an object detector that classifies objects, a false positive or true negative may arise with respect to a particular object class as a result of object misclassification

As described in further detail below, individual perception scores are not limited to simple counts of discrepant object detections. For example, the contribution of false positives and/or false negatives to the individual performance score may be weighted based on box size, so that smaller (typically more distance) object detections contribute less to the overall score. This is desirable in certain domains, such as robotics/autonomous driving, where nearby false positives or false negatives are generally more likely to have a detrimental effect on robot/autonomous vehicle performance. The contributions may also be weighted based on box overlap, which is useful to quantifying perception performance in the presence of partial object occlusion.

In generating the multiple pseudo-ground truth sets, each probability distribution (corresponding one of the actual computed outputs) is sampled multiple times, with possibly different outcomes, resulting in potentially different combinations of the possible ground truth outputs, against which the performance of the perception component is evaluated (resulting in possibly different performance scores across the set of pseudo-ground truth sets).

The method of the first aspect can be applied more generally to any perception component that may compute multiple outputs on a scene with a confidence score for each output.

Each output of the set of multiple computed outputs may, for example, be a (2D or 3D) bounding box or other bounding object (having a shape other than a box), or other form of detected object (e.g., segmentation mask).

The comparison of each detected object with each pseudo-ground truth set may be weighted by relative bounding object size.

The comparison of each detected object with each pseudo-ground truth set may be weighted by an extent of overlap with each other detected object.

The method may be used to identify a set of images/inputs and use the set of images/inputs to retrain the object detector. For example, the set of inputs may be identified from a larger group of inputs based on their relative performance scores (e.g., to select a relatively ‘hard’ set of images compared with the group as a whole, that can then be used to retrain the object detector).

In embodiments of the first aspect, the perception component may be an object detector and the set of multiple computed outputs may be a set of object detections.

Each pseudo-ground truth output may comprise either a positive existence indicator or a negative existence indicator. The performance score for each pseudo-ground truth set may be a perception hardness score, evaluated based on one or both of false positive detections and false negative detections with respect to that pseudo-ground truth set, where false positive detections are object detections whose confidence scores satisfy a minimum confidence threshold but which have a negative existence indicator in that pseudo-ground truth set, and where false negative detections are object detections whose confidence scores do not satisfy the minimum confidence threshold but which have a positive existence indicator of that pseudo-ground truth set.

Each object detection may, for example, define an object location and an object extent. For example, each object detection may comprise a bounding box or other bounding object defining the object location and the object extent.

Each pseudo-ground truth output may comprise either a positive existence indicator or a negative existence indicator, and the method may comprise: for each pseudo-ground truth set: generating for each positive existence indicator, a pseudo-ground truth object (e.g. bounding box) that defines an object location and object extent, and attempting to associate each object detection with a pseudo-ground truth object based on relative intersection therebetween; wherein the performance score for each pseudo-ground truth set is a perception hardness score, evaluated based on one or both of false positive detections and false negative detections with respect to that pseudo-ground truth set, wherein false positive detections are object detections whose confidence scores satisfy a minimum confidence threshold but which are not successfully associated with any pseudo-ground truth object of that pseudo-ground truth set, wherein false negative detections are object detections whose confidence scores do not satisfy the minimum confidence threshold but which have been successfully associated with a pseudo-ground truth object of that pseudo-ground truth set.

The performance score for each pseudo-ground truth set may, for example, be a count of false positive detections for that pseudo-ground truth set, a count of false negative detections for that pseudo-ground truth set, or a count of both false positive and false negative detections for that pseudo-ground truth set.

Computing the performance score for each pseudo-ground truth set may comprise computing, for each object detection of an error set a weighted error, which is an object size as a fraction of a size of the scene. The performance score may be computed by summing the weighted errors, and the error set may consist of all false positive detections for that pseudo-ground truth set, all false negative detections for that pseudo-ground truth set, or all false positive detections and all false negative detections for that pseudo-ground truth set.

For example, the scene may be a 2D image, each object detection may comprise a 2D bounding object defining the object location and the object extent, and the performance score may be computed as:

$${PixelAdj}_{x} ( e ( \hat{y} , y ) ) = {\sum }_{b ∈ e ( \hat{y} , y )} \frac{area ( b )}{area ( x )} ,$$

where y denotes the pseudo-ground truth set, y denotes the set of object detections, e(ŷ, y) denotes the error set for the pseudo-ground truth object set y, x denotes the scene, and b denotes a 2D bounding object.

The method of any of claims 2 to 5, wherein computing the performance score for each pseudo-ground truth object set comprises computing, for each object detection of an error set, an occlusion value, which is a measure of intersection between the object detection and any true positive detection as a fraction of object size, wherein the performance score is computed by summing the weighted errors, and wherein the error set consists of all false positive detections, all false negative detections, or all false positive detections and all false negative detections, true positives being detections whose confidence score satisfies the minimum confidence threshold and which have a positive existence indicator in that pseudo-ground truth set or which have been successfully associated with a pseudo-ground truth object of that pseudo-ground truth set.

For example, the scene may be a 2D image, each object detection may comprise a 2D bounding object defining the object location and the object extent, and the performance score may be computed as:

$${OccAware}_{x} ( e ( \hat{y} , y ) ) = {\sum }_{\begin{matrix}b ∈ e ( \hat{y} , y ) \\ {b}^{′} ∈ tp \{ x )\end{matrix}} \frac{inter ( b , {b}^{′} )}{area ( b )} ,$$

where y denotes the pseudo-ground truth set, ŷ denotes the set of object detections, e(ŷ, y) denotes the error set for the pseudo-ground truth object set y, x denotes the scene, b denotes a 2D bounding object, and tp(x) denotes the set of all true positives.

Each object detection may comprise an object class, and the object detections may be classified as false positive or false negatives with respect to a particular object class.

The method may be applied to multiple scenes to obtain respective overall performance scores for the multiple scenes. The overall performance scores may be to identify and mitigate a performance issue in the perception component.

For example, the perception component may be a trained machine learning component, and mitigating the performance issue may comprise re-training the perception component based on a subset of the multiple scenes selected based on their overall performance scores (e.g. re-training using relatively ‘hard’ scenes that have been identified).

The method may be applied to a time-sequence of multiple scenes to obtain respective overall performance scores for the multiple scenes, and may further comprise generating a graphical user interface that comprises a timeline of the overall performance scores and a visualization of the multiple scenes.

A second aspect herein provides a computer-implemented method of assessing performance of an object detector on a scene, the method comprising: receiving a set of object detections obtained by applying the object detector to the scene, each object detection including a confidence score; generating from the set of object detections multiple pseudo-ground truth object sets, wherein each pseudo-ground truth object set comprises, for each object detection, an existence indicator assigned thereto, wherein the existence indicator is sampled from a set of existence indicators based on a probability distribution defined by the confidence score of the object detection; for each pseudo-ground truth object set: comparing the set of object detections with the pseudo-ground truth object set, to identify any discrepant object detections of the set of object detections, a discrepant object detection having: a positive existence indicator in the pseudo-ground truth object set and a confidence score that does not satisfy a minimum confidence threshold, or a negative existence indicator in the pseudo-ground truth object set and a confidence score that does satisfy the minimum confidence threshold, and computing a performance score for the object detector applied to the scene with respect to that pseudo-ground truth object set based on the discrepant object detections; and computing an overall performance score for the object detector applied to the scene, by aggregating the performance scores computed with respect to the multiple pseudo-ground truth object sets.

The second aspect set out above may be considered an embodiment of the first aspect, applied to object detection.

Further aspects provide a computer system for assessing performance of an object detector on a scene, the computer system comprising one or more computers configured to implement the method any above aspect or embodiment, and a computer program comprising program instructions for programming a computer system to implement the same.

### BRIEF DESCRIPTION OF FIGURES

Particular embodiments will now be described, by way of example only, with reference to the following schematic figures, in which:

FIG. 1 shows a schematic function block diagram of a system for assessing the performance of a perception component on an unannotated scene.

FIG. 2 shows a first example of an analysis component that computes perception metrics.

FIG. 3 shows a possible optimization of the techniques of FIG. 2 that do not require pseudo-GT boxes to be computed.

FIG. 4 shows a simple example of a mean false positive count aggregated over individual false positive counts.

FIG. 5 shows, by way of context, a highly schematic block diagram of an AV runtime stack.

FIG. 6 shows an output of RetinaNet on an image from a COCO validation set and an output of CascadeNet on a frame from NuImages.

FIG. 7 illustrates a score sampling approach.

FIG. 8 shows confidence histogram plots for various detectors.

FIG. 9 shows correlation between proposed hardness measures on kitti and coco datasets for faster rcnn and retinanet detectors.

FIG. 10 illustrates evaluation metrics for ranking change with respect to number of Monte Carlo score samples.

FIG. 11 shows identified hardest images on the left and identified easiest images on the right for coco-rcnn.

FIG. 12 shows the results of repeating an analysis for mmdetmaskrcnn and examples of hardest images identified.

FIG. 13 shows histograms for estimated and actual numbers of false positives for coco-rcnn.

FIGS. 14-17 show cumulative ground-truth hardness for various hardness definitions for various detectors.

FIG. 18 shows cumulative ground-truth hardness of false=fn U fp boxes in images obtained with a fixed query budget for the pixel-adjusted hardness query.

FIG. 19 shows an example graphical user interface for analysing a driving scenario captured in a time-sequence of real world scenes.

### DETAILED DESCRIPTION

Perception performance metrics are a critical component of modern computer vision and ML-based perception. However, existing methods that utilize such metrics require high-quality ground truth as a benchmark for the analysis. Herein, a novel methodology is described, which allows such metrics to be used to quantify the same aspect or aspects of perception performance but on ‘unannotated’ scenes without such ground truth.

Among other things, the described methods can be applied with any object detector that provides a confidence score for each object detection. In brief, the confidence score is interpreted probabilistically as described below, allowing a pseudo-ground truth set to be generated by sampling a possible ground truth output for each object detection. Multiple pseudo-ground truth sets are generated for a given scene in this way. The performance of the object detector is quantified with respect to each pseudo-ground truth scene, and the results are aggregated to provide an overall performance score for the object detector on that scene.

The overall perception score is a good approximation to the corresponding perception scores that would be obtained via comparison with high-quality ground truth (e.g., manual ground truth, or ground truth generated via offline processing). In some instances, it may be that the overall performance scores across multiple scenes are a less accurate approximation in so far as their absolute values are concerned, whilst still having a good relative accuracy across the multiple scenes (in that, if ‘actual’ scores were assigned to a set of inputs with reference to ‘real’ ground truth, and then ordered by those scores, the order of the inputs will approximately match the order defined by their approximate performance scores computed using the present method). In other words, the overall performance scores computed using the present method may be accurate relative to each other, even if they exhibit a (potentially significant but nevertheless reasonably uniform) bias.

In computer vision and the wider field of ML-based perception, various standard or domain-specific metrics can be applied to numerically quantify the performance of a perception component on a scene with respect to a set of ground truth (GT) associated with the scene. An annotated scene refers to a scene having ground truth associated therewith, and an unannotated scene refers to a scene without such ground truth. The ground truth would typically be provided by way of manual annotation (for example, manually placed 2D or 3D bounding boxes around objects captured in a 2D or 3D scene).

Perception performance metrics may be applied during training (where the aim it to tune the parameters of the perception component to match its outputs to corresponding ground truth outputs on a training set)

Perception performance metrics may also be used, for example, in validation (to assess performance post-training on an annotated validation set), or as part of a wider testing/analysis (generally with the aim if identifying and mitigating issues with the perception component, for example, by identifying ‘hard’ scenes on which the perception component performs poorly, and using those hard scenes as a basis for re-training or otherwise re-engineering the perception component). Using the methodologies described herein, such metrics can be used e.g., during perception validation or performance testing without the need for expensive ground truth.

In object detection, one such class of metrics pertain to false (discrepant) object detection outputs; that is, false positive (FP) (or ‘ghost’) detections, false negative (FP) (or ‘missed’) detections, or overall false detections (positive and negative). The concepts of FP/FN detections apply to any perception component which attempts to discriminate between different objects (e.g., between different object instances and/or different object classes) that may be present in a multi-object scene, and the term ‘object detector’ is used broadly in this context to refer to any such perception component. As such, the term object detector herein covers not only bounding box (or other bounding object) detectors (2D or 3D), but other perception components such as segmentation networks or other segmentation components (that discriminate on a per-pixel basis between different object classes or instances present in a scene), or components that attempt to fit an object model or template to points or pixels in a scene (e.g. a perception component that fits 3D object models to respective subsets of object points within a 3D point cloud). Similar metrics may be applied but to quantify an aspect(s) of perception other than ‘hardness’. For example, similar metrics may be applied but to quantify true (rather than false) detections with respect to ground truth (e.g., to quantify true positive detections, true negative detections or overall true detections). False/true detection metrics can be formulated in various ways, but in general serve to quantify the extent to which a set of objects detected in a scene matches the ‘known’ object configuration encoded in the ground truth.

For the avoidance of any doubt, whilst the term “object detector” is sometimes used in the field of ML to mean specifically a bounding box detector that assigns an object classification to each bounding box, the term may be used in a broader sense herein. The term bounding box detector may be used to refer to a perception component that computes a bounding box (or other bounding object) for each detected object in a scene, or any other component that detects objects in a scene (such as a segmentation component that computes an object segmentation mask). The bounding box detector may or may not classify each box in relation to a set of defined object classes.

True/false detection metrics are merely one class of metric for assessing perception performance with respect to ground truth. Other forms of perception metric include, for example, numerical error functions, e.g., which quantify position, orientation and or size error with respect to pseudo-ground truth, or intersection over union between a detected object (e.g. detected bounding box, detected segmentation mask etc.) and a corresponding ground truth object (e.g. pseudo-GT bounding box, pseudo-GT segmentation mask etc.). Whilst the following examples consider true/false detection metrics in the context of object detection, the present techniques can be applied with any perception performance metric that scores performance relative to ground truth, and with any perception component that is able to compute multiple outputs on a given scene with a confidence score for each output that can be interpreted probabilistically for the purpose of sampling multiple pseudo-ground truth outputs for the scene.

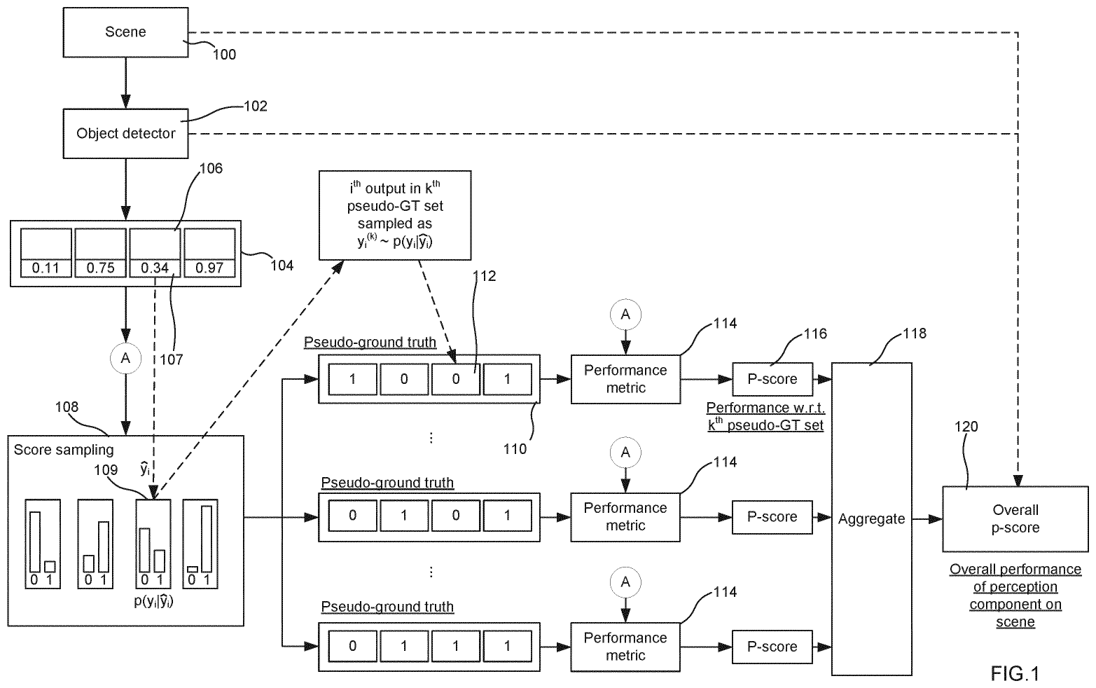

FIG. 1 shows a schematic function block diagram of a system for assessing the performance of a perception component 102 on an unannotated scene 100.

When applied to the scene 100, the perception component 102 computes a set 104 (output set) that can include multiple computed outputs (detections). Reference numeral 106 denotes a computed output, and each computed output 106 comprises a confidence score 107 denoting a level of confidence in that detection assigned by the perception component 102. In mathematical notation, [symbol] denotes the confidence score 107 of the i^{th} output 106 of the output set 104.

In the following examples, the perception component takes the form of an object detector 102, and specifically a bounding box detector. Here, each output 106 comprises a set of parameters defining the extent and location of a 2D or 3D bounding box for an object detected in the scene 100. However, as noted, the described techniques can be applied more generally to any form of perception component 102 that computes multiple outputs with a confidence score for each output. For example, Algorithm 4 below could be applied to a detector that detects object locations but does not estimate their extent, or even an object detector that simply returns a list of objects.

The following examples consider a bounding box detector 102 that additionally classifies each box an object class (e.g. a set of object classification scores, with the highest score denoting the assigned object class). The described techniques can optionally incorporate object classification outputs, by extending the definition of false positive/negative detections to include the case of a mismatch between an object class assigned to a detected box and a different class assigned to a corresponding ground truth box. In that case, when a detected box (positive detection) does correspond to a ground truth box, but there is a mismatch between the detected class and the ground truth class, that may be characterized as both a false negative (on the ground truth class) and a false positive (on the detected class).

With classification scores, a class may be signed to a detection e.g. based on the highest classification score. In generating a pseudo-ground truth scene, the classification score may be sampled in the same way, which may result in the same or a different object classification. The latter case may result in a false positive detection (on the different object class) and a false negative (on the detected class).

Based on the confidence scores of the output set 104, a score sampling component 108 generates multiple sets of “pseudo-ground truth” for the scene 100. Reference numeral 110 denotes the kt^{h} pseudo-GT set. The principles of “score sampling” are described in detail below. In brief, the score sampling component 108 interprets the confidence score 107 of each detection 106 as denoting a probability that the detection 106 is true. Under this interpretation, a probability distribution, p( [symbol] | [symbol] ) is constructed, where [symbol] denotes an (unknown) ground truth “existence indicator”, such that [symbol] =1 implies the existence of an object (positive existence indicator), and [symbol] =0 implies the object does not actually exist (negative existence indicator). As will be evident, the choice of “1” to represent existence and “0” to represent non-existence is arbitrary, and any existence indicators can be used to discriminate between existence and non-existence.

In more general terms, the confidence score 107 of detection 106 is interpreted as defining a probability distribution over a set of possible ground truth outputs corresponding to the detection 106.

Note the output set 104 is a “full” set of object detections, including low confidence detections. Later in the process, a confidence threshold is applied to distinguish negative detections (confidence below the threshold) from positive detections (confidence above or equal to the threshold). Under this formulation, a true positive detection implies a confidence score that meets the threshold and true existence indicator ( [symbol] =1) (positive detection and positive existence indicator). A true negative detection implies a confidence score below the threshold and a false existence indicator ( [symbol] =0) (negative detection and negative existence indicator). A false positive detection arises with a confidence score that meets the threshold (positive detection) but a negative existence indicator (the object does not ‘actually’ exist), whilst a false negative detection arises with a confidence score below the confidence threshold (negative detection) but a positive existence indicator (the object does ‘actually’ exist).

Because the scene is unannotated, the existence indicator is unknown [symbol] . Instead, the score is interpreted as a probability of a true existence indicator, such that a statistically plausible set of existence indicators is sampled for each detection 106 across the multiple pseudo-GT sets 110. In other words, it is not known whether the object actually exists, but the confidence score is interpreted as a probability of object existence.

Reference numeral 112 denotes the i^{th} sampled existence indicator in the kt^{h} pseudo-GT set 110. This may be expressed in mathematical notation as [symbol] ˜p( [symbol] | [symbol] ).

A performance metric 114 is used to quantify performance of the object detector 102 on the scene 100 based on a comparison of the object detector output 104 with ground truth. In this case, there is no single, authoritative source of ground truth for the scene 100. Rather, the performance metric 114 is applied multiple times, to quantify perception performance with respect to each pseudo-ground truth set 110. This results in an individual perception performance score (p-score) 116 for each pseudo-GT set 110.

The individual p-scores 116 are aggregated, by an aggregation component 118, to provide an overall p-score 120 for the object detector 102 applied to the scene 100 for the performance metric 114 in question. As set out in more detail below, the overall p-score is a good approximation of the score that would be obtained if the metric 114 were applied to the scene 100 with respect to actual ground truth.

Note that, whilst the described techniques do not require annotated scenes, they can nevertheless be applied to annotated scenes, independently of their ground truth. For example, the described techniques may be applied to annotated scenes in order to validate the present techniques (that is, to see how the present techniques applied to a scene with a given object detector and perception performance metric compare, independently of its ground truth, to the same performance metric applied to the scene ground truth in the conventional manner).

The perception metric 114 can be defined and applied in various ways.

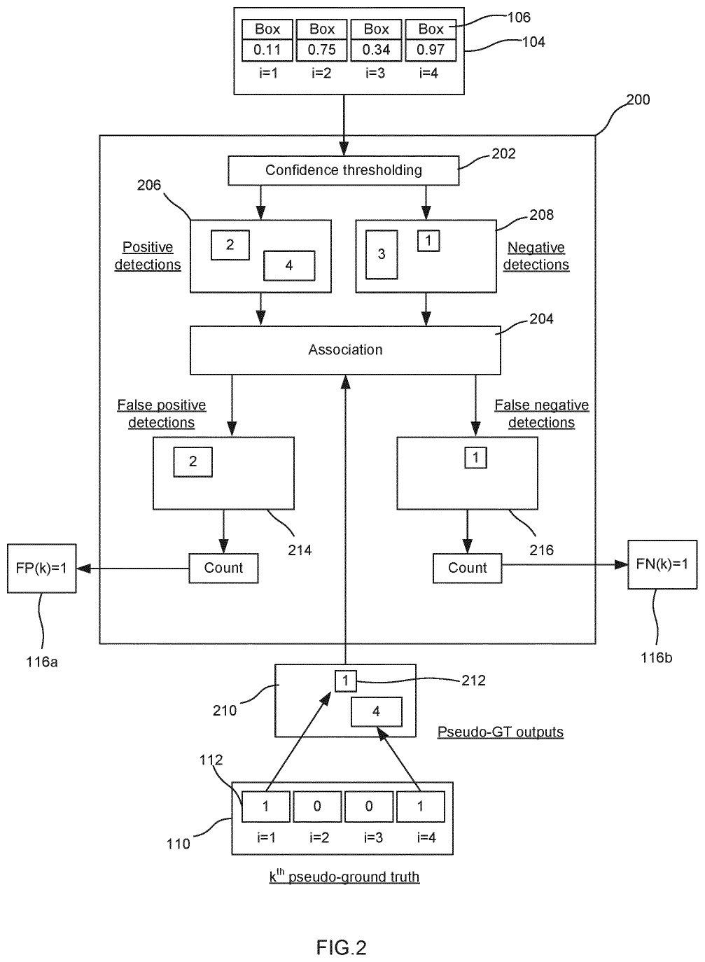

FIG. 2 shows a first example of an analysis component 200 that computes perception metrics in the form of simple FP and FN counts 116a, 116b with respect to a given pseudo-GT set 110. The logic of the analysis component 200 broadly corresponds to Algorithm 1 below.

A thresholding component applies a confidence threshold to an output set 104, to divide the output set into a positive detection subset 206 (any detections satisfying the confidence threshold) and a negative detection subset 208 (any detections not satisfying the confidence threshold).

The pseudo-GT set 110 is formed of positive/negative existence indicators for all detected objects in the output set 104 (including negative detections below the confidence threshold), sampled based on the detection confidence scores as described above.

The pseudo-GT set 110 is used to construct a pseudo-ground truth output set 210 for the scene 100. In this example, the pseudo-GT output set 210 includes a pseudo-GT bounding box for only each object, i, having a positive existence indicator 112. In this example, each pseudo-GT outputs 212 has the form of a bounding box. More generally, the pseudo-GT outputs are constructed to match the form of the perception component outputs 106, in order to facilitate a direct comparison between the pseudo-GT outputs 210 and the output set 106.

An association component 204 receives the positive and negative detection subsets 206, 208 and the pseudo-GT output set 210, and attempts to associate each computed output with a pseudo-GT output. For example, existing methods such as Intersection-over-Union (IoU) can be used to match computed boxes to pseudo-GT boxes based on their relative intersection.

There are four possible outcomes, and the result of the association step can be any combination of these:
a positive detection may be successfully matched to a pseudo-GT box (true positive),
it may not be possible to match a positive detection to any pseudo-GT box (false positive).
it may not be possible to match a negative detection to any pseudo-GT box (true negative), and
a negative detection may be successfully matched to a pseudo-GT box (false positive).

Thus, each object detection may be classified in relation to the set {TP, TN, FP, FN}.

In this example, the result is a subset of false positive detections 214 and a subset of false negative detections 216, from which the FP and FN counts 116a, 116b are generated. Although not depicted, the same techniques can alternatively or additionally be used to count e.g., overall false detections (positive and negatives) or true positives.

As noted, the techniques can be extended to other perception performance metrics. For example, as described in detail below, rather than simply counts of FP/FN detections, FP/FN detections could be weighted by pixel count (the number of pixels encompassed by a given box, such that more distance boxes contribute less to the p-score), or by box overlap etc.

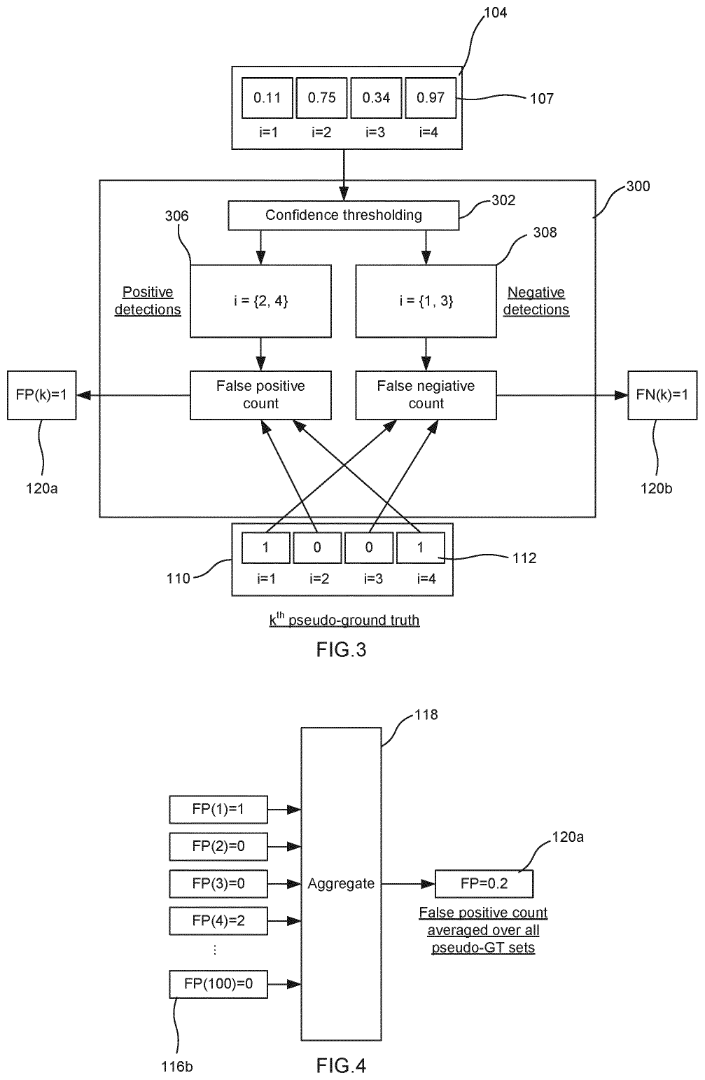

FIG. 3 shows a possible optimization of the techniques of FIG. 2 that do not require pseudo-GT boxes to be computed, broadly corresponding to Algorithm 4 below. Instead, p-scores are derived directly from the object existence indicators of the pseudo-GT set 110 by a second analysis component 300.

In this example, objects are indexed (where i denotes the index of an object), and a confidence thresholding component 302 operates in the essentially same manner as described above, but with the difference that positive and negative detection subsets 306, 308 need only be denoted at the level of object indexes. Detections can then be classified for computing the p-score in the same manner, but on the object indexes directly:
true positive: any object i in the positive detection subset 306 having a positive existence indicator,
false positive: any object i in the positive detection subset 306 having a negative existence indicator,
true negative: any object i in the negative detection subset 308 having a negative existence indicator, and
false negative: any object, i, in the negative detection subset 308 having a positive existence indicator.

This assumes a mapping is maintained between computed outputs of the output set 104 and corresponding existence indicators in the pseudo-GT set 110, to allow each confidence score 107 of the output set 104 to be matched to a corresponding existence indicator 112 of the pseudo-GT set 110.

In the examples of FIG. 2 and FIG. 3, object i=1 in the output set 104 is a false negative (below confidence threshold but existence indicator of 1), object i=2 is a false positive (above confidence threshold but existence indicator 0), object i=3 is a true negative (below confidence threshold and existence indicator 0), and object 4 is a true positive (above confidence threshold and existence indicator 1). As noted, these detection classifications pertain to a specific pseudo-GT set 110. Different pseudo-GT sets may have different existence indicators for the same object, as a result of different sampling outcomes, thus the same object may be classified differently for different pseudo-GT sets.

FIG. 4 shows a simple example of a mean false positive count 120a aggregated over the individual false positive counts 116b obtained over a relatively large number of pseudo-GT sets. This is one example of an overall p-score obtained by aggregating individual p-scores over multiple pseudo-GT sets.

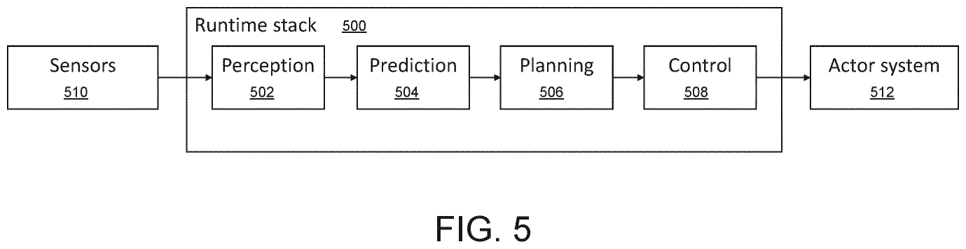

FIG. 5 shows, by way of context, a highly schematic block diagram of an AV runtime stack 500. The run time stack 500 is shown to comprise a perception system 502, a prediction system 504, a planning system (planner) 506 and a control system (controller) 508.

In a real-world context, the perception system 502 receives sensor outputs from an on-board sensor system 510 of the AV, and uses those sensor outputs to detect objects (such as external agents, static object etc.) and measure their physical state, such as their position, velocity, acceleration etc. The on-board sensor system 510 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 510 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc. The perception system 502 typically comprises multiple perception components which co-operate to interpret the sensor outputs and thereby provide perception outputs to the prediction system 502. In a simulation context, synthetic sensor data may be fed to the perception system 502, as generated using high-fidelity sensor models. Note that the present techniques can be used to quantify hardness of synthetic scenes. Alternatively, the perception system 502 (or a portion or portions thereof) may be replaced with a surrogate model(s) operating on lower-fidelity inputs from the simulator.

Predictions computed by the prediction system 504 are provided to the planner 506, which uses the predictions to make autonomous driving decisions to be executed by the AV in a given driving scenario. A core function of the planner 506 is the planning of trajectories for the AV (ego trajectories), taking into account predicted agent motion. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown). The controller 508 executes the decisions taken by the planner 506 by providing suitable control signals to an on-board actor system 512 of the AV. In particular, the planner 506 plans trajectories for the AV and the controller 508 generates control signals to implement the planned trajectories.

The example of FIG. 5 considers a relatively “modular” architecture, with separable perception, prediction, planning and control systems 502-508. The extent to which the various stack functions are integrated or separable can vary significantly between different stack implementations—in some stacks, certain aspects may be so tightly coupled as to be indistinguishable. At the extreme, in so-called “end-to-end” driving, perception, prediction, planning and control may be essentially inseparable. Unless otherwise indicated, the perception, prediction, planning and control terminology used herein does not imply any particular coupling or modularity of those aspects. It will be appreciated that the term “stack” encompasses software and/or hardware.

The present techniques can, for example, be used to test and refine the perception system 502 of the AV stack 100, or an individual component(s) of the perception system 502. Hence, the perception system 502 of FIG. 5 may comprise the perception component 102 of FIG. 1. The described techniques may, for example, be used to test and improve the performance of the perception component 102, which may in turn improve the performance of the AV stack 500.

In some implementations, the perception component 102, e.g. object detector, may be applied as part of the performance assessment method itself. For example, the perception component 102 could be applied ‘offboard’ (e.g. in a backend system) to a set of images/scenes previously collected by a sensor-equipped vehicle, to generate the corresponding detections at the point perception performance is assessed. In other implementations, the perception component 102 may be applied in advance, and the detections may be stored for use in a later assessment of perception performance. For example, an AV (or a perception-equipped vehicle more generally) may apply the object detector ‘on-board’ in a driving context, and store the images/scenes and their object detection outputs generated on the vehicle. The images and detections may then be retrieved at a later time, and the present techniques can be utilized to assess the on-board detector performance within the vehicle's perception system 502.

Further implementation details will now be described by way of example only. The following examples consider images. However, the techniques can be applied to scenes such as lidar or radar point clouds.

The following description uses a somewhat modified notation. In the above description and in FIG. 1, an existence indicator for the ith detection and kth pseudo-ground truth is denoted [symbol] ˜p( [symbol] | [symbol] ), where ŷᵢ denotes the confidence score for the ith detection. The following description denotes the existence indicator by Xᵢ, and uses ŷᵢ to denote a bounding box output comprising a bounding box bᵢ, a class label cᵢ and a detection probability vector pᵢ assigning a probability to each class. The class label cᵢ is the index of the component having the highest probability, and thus denotes the highest probability class, i.e., cᵢ=argmaxₖpᵢ(k) where pᵢ(k). In this notation, the confidence score for detection i is therefore denoted by pᵢ(cᵢ) (equivalent to ŷᵢ in the above description and FIG. 1). As above, this is interpreted as a probability, and used to construct a Bernoulli distribution (109 in FIG. 1) from which the existence indicator Xᵢ is sampled, denoted as Xᵢ˜Bernoulli(pᵢ(cᵢ) (rather than p( [symbol] | [symbol] ).) (108 in FIG. 1).

There is a longstanding interest in capturing the error behaviour of object detectors at test time by finding images where their performance is likely to be unsatisfactory. In real-world applications such as autonomous driving, it is moreover crucial to characterise potential failure cases beyond simple requirements of detection performance. For example, a missed detection of a pedestrian close to the ego vehicle will generally require closer inspection than a missed detection of a car in the distance, since it is more likely to directly result in injury or death. This problem of finding such failure cases at test time has been largely overlooked in the literature and conventional approaches based on detection uncertainty fall short in that they are agnostic to such fine-grained characterisation of errors. The following embodiments formulate this problem as a query-based hard image retrieval task, where each query is a specific definition of “hardness”, and offer a simple and intuitive method that solves this task for any query and any object detector. The described method is entirely post-hoc and uses on a Monte Carlo approximation of the hardness definitions, obtained by sampling from a simple but effective stochastic model of the ground-truth obtained from the detection scores. It is demonstrated experimentally that the method can be applied successfully to a wide variety of queries for which it can reliably identify query-specific hard images without any labelled data.

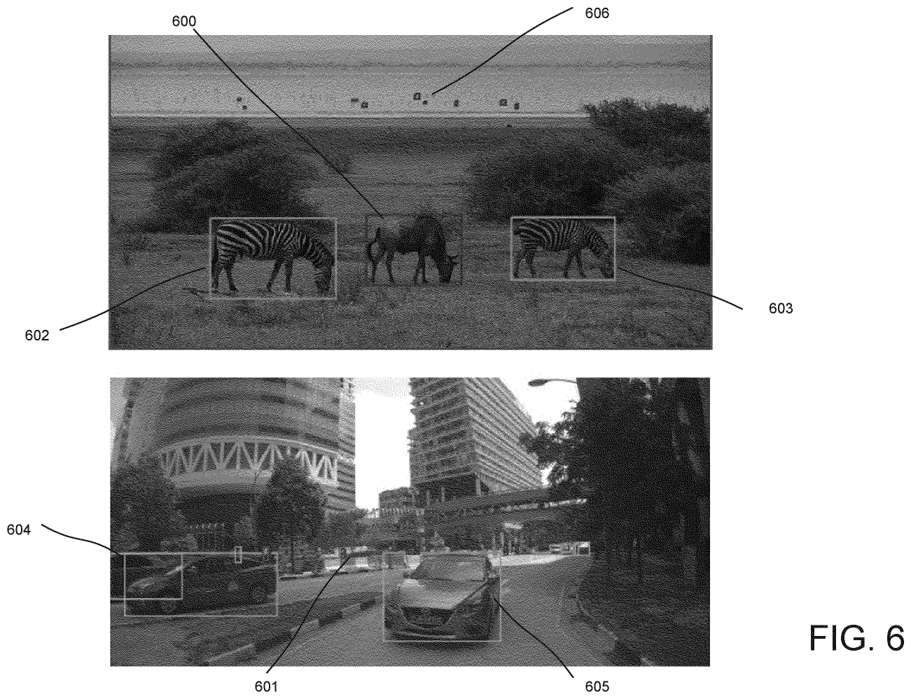

How difficult (or hard) an image can be for an object detector at inference? Though answering this very question, primarily for image classification tasks, has been central to a large body of work ranging from reliable uncertainty estimation to active learning, herein the same question is revisited in the context of object detection and a novel view to it is presented. The example implementation described below is based on the observation that, as opposed to the standard classification tasks, there is no clear definition of ‘hardness’. An image can be considered harder than another one if the detector produced too many false positives on it. Similarly, an image can be considered harder if the detector makes more mistakes on nearer objects than on far ones (refer to FIG. 6 for motivating examples). Hardness is task-specific for object detectors. In FIG. 6, boxes 602-605 denote true positives, boxes 600-601 denote false positives and boxes 606 denotes false negatives. The top image is the output of RetinaNet on an image from the COCO validation set [16]. Is this image hard for RetinaNet because of the misclassified wildebeest in the foreground or because of the undetected birds in the background? The bottom image is the output of CascadeNet [5] on a frame from NuImages [4] (another example in an autonomous vehicle context). Should this example be considered a hard one because of the undetected pedestrians even though they are farther away compared to the correctly detected cars?

Therefore, depending on the requirements, the definition of hardness would vary, and one should be able to quantify it accordingly. However, the widely used metrics to quantify the so-called hardness, such as entropy and Dempster-Shafer to name a few, are completely agnostic to such task-specific requirements.

Herein, a framework is provided that allows characterising a large family of requirement specific hardness definitions, referred to as query-based hardness herein (in this context, a query means a particular hardness definition or, more generally, a particular definition of perception performance). The central idea here is to provide fine-grained error behaviours of a detector (e.g., set of false-negative and false-positive bounding boxes) to allow a user to compose a large family of complex queries. For example, if provided with the set of potential false positive and false negative bounding boxes, a user may compose a query and define hardness as a metric that quantifies how severe the mistakes are in these sets, and similarly for other elements in the error behaviour set.

An algorithm (Score sampling (SS)) is provided to quantify the hardness for these user-defined queries. For a given query-based hardness definition, SS first defines a distribution of pseudo ground-truth bounding boxes and then computes expected hardness via efficient Monte Carlo estimation.

### Defining Query-Based Hardness

### Object Detector

Denoting a general object detector as a function D_{η}: x [symbol] ŷ that maps an input image x to a list of detection instances ŷ, where each instance [symbol] =(bᵢ, cᵢ, pᵢ) comprises, e.g., a regressed bounding box bᵢ enclosing the i-th detected object, a class label cᵢ∈{1, . . . , K}, and detection probability vector pᵢ. Here ŷ denotes the final output of the detector (e.g., after non-maximal suppression (NMS) or any other post-processing) and η is typically chosen according to the task specific requirements for trade-offs of precision and recall. Note, cᵢ=argmaxₖpᵢ(k) where pᵢ(k) is the probability assigned to the k-th class. Here η is the output threshold (minimum confidence threshold) such that only instances with pᵢ(cᵢ)≥η are produced by the detector D_{η}. It is assumed that pᵢ(k) builds a categorical distribution over K classes with pᵢ(k)=exp sᵢ(k)/Σⱼ exp sᵢ(j) where sᵢ is a logit corresponding to pᵢ, but the description also applies as well to one-vs-all binary setups. A ground-truth instances is denoted by y={ [symbol] }ᵢ, where each instance is of the form [symbol] =(bᵢ, cᵢ). No further assumptions are made regarding the architecture or training procedure of the detector. The box bᵢ defines an object location and extent, in terms of bounding box coordinates.

### Image Hardness the Conventional Way

The most common way to capture how difficult or hard a certain input is for a specific model at test time is to compute the entropy of its predictive distribution. For object detection, the overall entropy per image can be computed as

$${H}_{x} ( \hat{y} ) = - {\sum }_{i} {\sum }_{k} {p}_{i} ( k ) log {p}_{i} ( k ) , \qquad ( 1 )$$

where pᵢ(k) denotes the probability with which i-th bounding box belongs to the k-th category. This captures the total uncertainty associated with an image as the sum of entropy for each predicted bounding box.

Recently, the Dempster-Shafer (DS) framework received significant attention in image classification tasks and was shown to capture uncertainty reliably for out-of-distribution detection problems. Contrary to the entropy, this metric is defined in terms of the evidence (also known as belief) per class instead of their probabilities, which is defined as eᵢ(k)=exp sᵢ(k). The per-image DS uncertainty measure can then be written as:

$$D {S}_{x} ( \hat{y} ) = {\sum }_{i} \frac{K}{K + {\sum }_{k} {e}_{i} ( k )} , \qquad ( 2 )$$

where, similarly to Hₓ(ŷ), the sum is over all the detected instances i in the image.

Even though Hₓ(ŷ) and DSₓ(ŷ) can be used to quantify at test time how likely it is that a detector will make a mistake on a given image, this notion of “hardness” is extremely crude as it does not allow to specify arbitrary requirements of performance. In real-world applications, it is crucial to have a more fined-grained characterisation of detection errors since different types of errors can have vastly different consequences for a downstream task. For example, in the domain of autonomous vehicles, missing a pedestrian close to the ego vehicle will generally be considered a much more dangerous mistake than having a false-positive detection of a car in the distance (see FIG. 6 for an illustration). Both the above discussed metrics do not allow specifying such requirements. Therefore, in this sense, they both suffer from the fact that they are agnostic to the specific performance measure under consideration.

### Query-Based Hardness

As discussed, for object detection, the very concept of image hardness inherently requires the specification of a notion of performance. The dependence on a performance metric is implicit in the case of classification, where there is a unique and well-defined definition of error, i.e., a misclassification. For object detection, this needs to be made explicit as there are a large number of independent possible errors that can be considered, such as class errors, location errors, size errors, etc.

Suppose that, for each image x, access to corresponding ground-truth bounding boxes y is available. Evidently, this requirement will not be fulfilled at test time and in the following section, an efficient approach to instead approximate it. However, for the time being, proceeding with the assumption that access to y is available then, for a given image x with detection instances ŷ=D_{η}(x) and ground-truth bounding boxes y, and algorithm such as the Hungarian algorithm may be used on a thresholded intersection-over-union cost matrix [9] to define the error sets e(ŷ, y)∈{fp(ŷ, y), where fp and fn denote the set of false-positive and false-negative bounding boxes, respectively, and false=fp∪fn is the set of all the fp and fn boxes. Note that the set of false-negative boxes consists of those ground-truth instances that have not been associated to any detection.

Once the above fine-grained information about the possible error categories is defined, several domain-specific queries regarding the behaviour of a detector can be introduced. For example, one could consider the relative position of the false-negatives and false-positives to be more informative in defining hardness or might want to pay more attention to a particular class (for example, pedestrians) and define the hardness accordingly, and so on. Hereinbelow, various query-specific hardness definitions are considered to show the generality of the approach. However, depending on the task, more expressive queries can easily be constructed. Hence, the described techniques can be applied with any desired perception performance metric defined with respect to ground truth (or pseudo-ground truth-see below).

### Examples of Query-Based Hardness

### Total Number of Errors

An image x is considered harder than x′ if the detector makes a larger number of errors of a given type on that image, that is if |e(ŷ, y)|>|e(ŷ^{t̅}, y′)|. A hardness query is denoted as Totalₓ(e(ŷ, y)=|e(ŷ, y)|. Here, e(*, *) is an error function, which returns set of errors, i.e. object detections that are discrepant with respect to the given ground truth (e.g. all false positives, all false negatives or all false detections). The Totalₓ(*) function is simply a count of elements in a given set. Whilst a simple error count is a sufficient hardness metric in some contexts, other forms of hardness metric are considered.

### Pixel-Adjusted Errors

In some contexts, errors on large objects may be considered to be more severe than errors on smaller objects. This motivates the introduction of pixel-adjusted versions of the above queries. To do so, each error is weighted by the size of the corresponding bounding box as a fraction of the total image, and the pixel-adjusted error is defined as

$${PixelAdj}_{x} ( e ( \hat{y} , y ) ) = {\sum }_{b ∈ e ( \hat{y} , y )} \frac{area ( b )}{area ( x )} , \qquad ( 3 )$$

where area(.) denotes the area of the image x or bounding box b as applicable.

### Occlusion-Aware Errors

In some contexts, an image with many occluded objects may be considered to be harder than the less ‘cluttered’ images. In the absence of 3D information, a reasonable assumption may be made that overlap with true positive boxes is a good proxy for measuring occlusions. Similarly, to the pixel-adjusted case, occlusion-aware hardness may be quantified as:

$${OccAware}_{x} ( e ( \hat{y} , y ) ) = {\sum }_{\begin{matrix}b ∈ e ( \hat{y} , y ) \\ {b}^{′} ∈ tp ( x )\end{matrix}} \frac{inter ( b , {b}^{′} )}{area ( b )} , \qquad ( 4 )$$

where, inter(b, b′) is the area of the intersection between b and b′.

### Quantifying Query-Based Hardness

Previously, it was assumed that the ground-truth bounding boxes were available in order to define the fine-grained error sets. In what follows, an approach is presented to approximate a distribution of ground-truth (referred to herein as pseudo ground-truths). An efficient approach to quantify query-specific hardness is also presented.

The approach of generating pseudo ground-truths can be implemented straightforwardly and efficiently. One insight is to treat detection scores of detected instances as posterior predictive probabilities. Motivated by this insight, samples from their implied distribution are used to estimate a given hardness query. More precisely, for a given image x, first a set of detected instances ŷ₀=D₀(x) is obtained. Then, for each detected instance [symbol] =(bᵢ, cᵢ, pᵢ)∈\dot{ŷ}₀, a Bernoulli distributed random variable (existence indicator) Xᵢ˜Bernoulli(pᵢ(cᵢ)) is defined, which is parameterised by the detection score pᵢ(cᵢ). Therefore, if |ŷ₀|=m, a multivariate Bernoulli distribution is determined with m independent variables. Pseudo ground truth \tilde{y} is generated by selecting each detection instance [symbol] ∈ŷ₀ independently according to its Bernoulli distribution, i.e. if Xᵢ=1. This generates a distribution P(\tilde{y}) over pseudo-ground truths.

In a more general form, query-specific hardness metrics (e.g., Eq. 3) can be denoted as qₓ(ŷ, \tilde{y}), where \tilde{y} denotes the pseudo ground-truth. With access to the distribution P(\tilde{y}), the expected hardness may be computed per query using Monte Carlo estimator with N samples as:

$$\begin{matrix}S {S}_{x} ( \hat{y} ; q ) = {𝔼}_{\hat{y} ∼ P ( \tilde{y} )} [ {q}_{x} ( \hat{y} , \tilde{y} ) ] \\ = \int {q}_{x} ( \hat{y} , \tilde{y} ) dP ( \tilde{y} ) \\ \approx \frac{1}{N} {\sum }_{j = 1}^{N} {q}_{x} ( \hat{y} , {\tilde{y}}^{j} ) , {\tilde{y}}^{j} ∼ P ( \tilde{y} ) .\end{matrix} \qquad ( 5 )$$

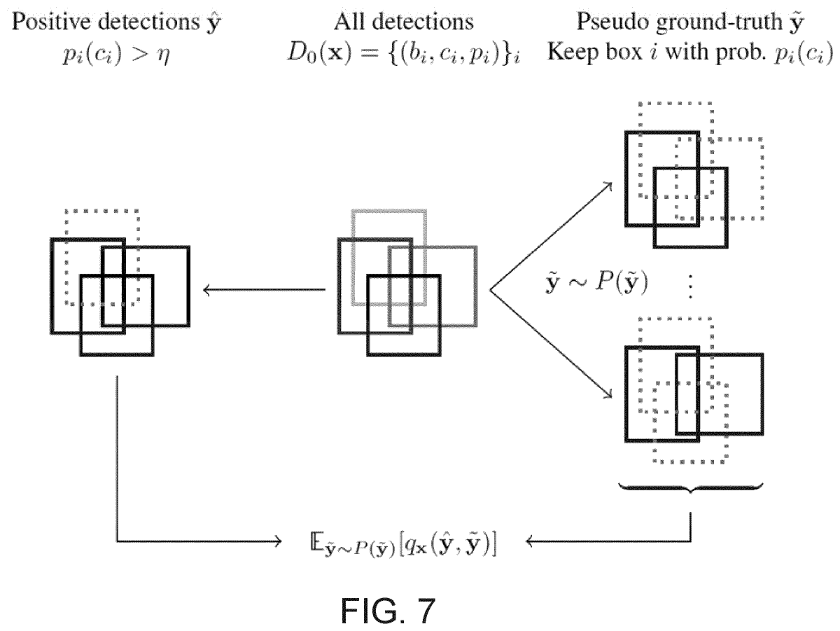

The above methodology is referred to herein as score sampling. A score sampling algorithm is summarized in Algorithm 1. Note that sampling \tilde{y}˜P(\tilde{y}) is extremely efficient as it typically involves m≈200 parallelizable Bernoulli trials. An illustration of the score sampling approach is given in FIG. 7. In FIG. 7, starting from all detections (η=0) pseudo-ground truth annotations are generated by selecting each box with probability given by their detection score pᵢ(cᵢ) and used to evaluate positive detections (pᵢ(cᵢ)>η) in place of the ground truth using the performance query q, see Algorithm 1 for details.

Algorithm 1: Score sampling

| Data: image x, detector D_{η}, hardness query | |
|---|---|
| qₓ(ŷ, y), number of samples N. | |
| Result: Estimated hardness q̅ using score sampling. | |
| ŷ₀ < D₀(x); | |
| for k + 1 to N do | |
| \| for (bᵢ, cᵢ, sᵢ) ∈ ŷ₀ do | |
| \| \| Let U be a randomly distributed float in | |
| \| \| [0, 1]; | |
| \| \| Xᵢ ← U < sᵢ; | # Sample from |

| | Bernoulli random variable
| end
| \tilde{y}^{(k)} ← {(b_{i,} cᵢ) for (bᵢ, cᵢ, sᵢ) ∈ ŷ₀|Xᵢ = 1};
end
ŷ^ ← {bᵢ, cᵢ, sᵢ) ∈ ŷ₀|sᵢ > η};
$\overline{q} ← \frac{1}{N} {\sum }_{k = 1}^{N} {q}_{x} ( \hat{y} , {\tilde{y}}^{( k )} ) ;$

A key assumption in the above process is the following: a detector will usually assign a low probability to ambiguous (or incorrectly classified) objects. Therefore, even if the assigned probability is not low enough for the box to be rejected by the detector, using this probability as the parameter of the Bernoulli distribution will most likely lead to multiple unsuccessful events (as pᵢ(cᵢ)<<1), hence, the so-called ambiguous/incorrect bounding box might not become part of various sampled pseudo ground-truths. Similarly, the correctly classified bounding boxes will most likely be part of the pseudo ground-truths as pᵢ(c)≈1 will almost always lead to a success event in Bernoulli trials. A failure case for such Bernoulli trials would be when the detector is wrong with very high confidence, however, since the detectors normally show good calibration properties, such situations are not expected to arise frequently.

The efficiency of Algorithm 1 can be improved by avoiding the association step which is often a part of hardness functions, f, by maintaining an association between detections and pseudo ground truth boxes during the sampling step. Such an algorithm is presented in Algorithm 4, referred to as continuous score sampling. In Algorithm 4, true positive, false positive and false negative counts are computed directly from the sampled existence indicators based on the known associations. Note, in algorithm 4, the minimum confidence threshold is denoted as t. Algorithm 4 does not rely on relative intersections and could therefore be applied to a detector that detects object locations but does not estimate their extent, or even a detector that simply returns a list of detected objects.

Algorithm 4: Continuous score sampling

Data: image: x, detector: D, number of samples N, detector threshold t,
hardness function g(#tp. #fp, #fn)
Result: expected hardness prediction [symbol] [h] [symbol]
= D(x, η = 0);
for k ← 1 to N do
| for (bᵢ, cᵢ, sᵢ) ∈ [symbol] do
| | Let U be a randomly distributed float in [0, 1];

| | |
|---|---|
| \| \| Xᵢ ← U < sᵢ; | /* Sample from Bernoulli random variable */ |

| end
| z^{(k)} ← {bᵢ, cᵢ, sᵢ, Xᵢ)};

| | |
|---|---|
| \| ; | /* The below expressions avoid having to do association */ |

| #tp^{(k)} = Σᵢ Xᵢ [symbol] [sᵢ ≥ t]
| #fp^{(k)} = Σᵢ (1 − Xᵢ) [symbol] [sᵢ ≥ t];
| #fn^{(k)} = Σᵢ Xᵢ [symbol] [sᵢ < t];
end
$𝔼 [ h ] ← \frac{1}{N} {\sum }_{k = 1}^{N} g ( \# {tp}^{( k )} , \# {fp}^{( k )} , \# {fn}^{( k )} ) ;$
$p ( h > γ ) ← \frac{1}{N} {\sum }_{k = 1}^{N} [ g ( \# {tp}^{( k )} , \# {fp}^{( k )} , \# {fn}^{( k )} ) > γ ]$

In Algorithm 4, the true positive count (tp) is equal to the number of pseudo-GT objects whose associated detection scores are above the detector threshold. The false negative (fn) count is equal to the number of pseudo-GT objects whose corresponding detection scores are below the threshold. The false positive (fp) count is equal to the number of detections whose scores are above the threshold and which have no associated pseudo-GT object.

### Detector Calibration

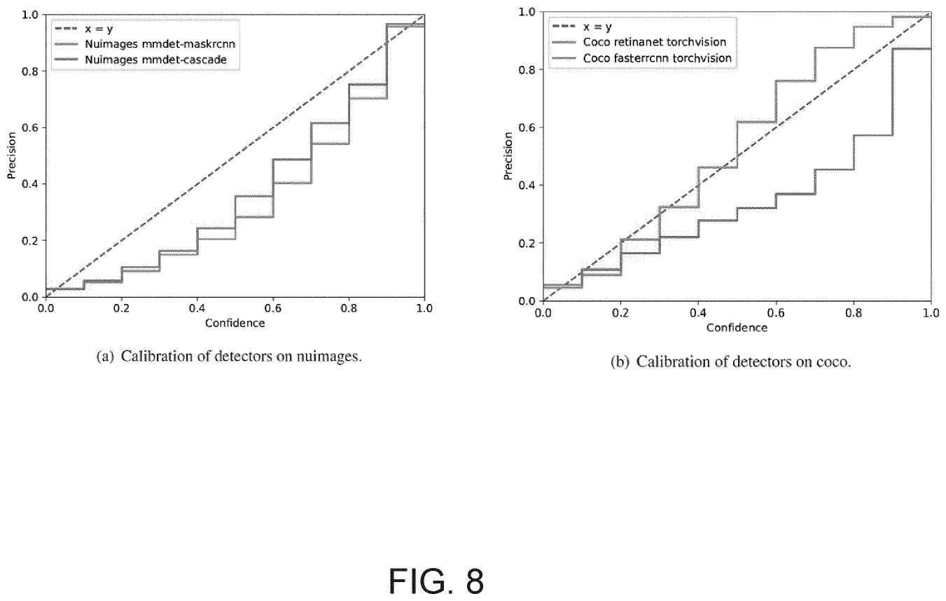

FIG. 8 shows confidence histogram plots for each of these detectors. These confidence histograms are produced by taking all of the bounding boxes for each detector-dataset combination and attempting to associate them with ground truth annotations; binning the detected boxes by score enables a calculation of precision for each bin. For most bins, the detectors are overconfident in their detections, i.e., the rate of detection is lower than that which would be implied from a probabilistic interpretation of the detected box scores. However, the accuracy monotonically increases as confidence increases, i.e. the ordering of the boxes by score is approximately correct. Although one would expect this miscalibration to have a dire effect on the efficacy of score sampling, because the number of false positives should be underestimated and the number of false negatives overestimated, in practice our experiments show that score sampling is an effective method of identifying hard images because this bias is reasonably uniform, meaning the relative order of the scores is generally correct.

### User Interface

In one use case, the above techniques may be applied to each scene in a time-sequence of captured scenes (such as a video image, where the method is applied to each frame; or a time sequence of lidar or radar point clouds etc.). This provides a time-sequence of overall hardness scores (one per frame), which convey the relative hardness of the frames/scenes across the sequence. For example, in autonomous driving testing, the scenes might be captured using an on-board sensor of a vehicle during a real-world driving scenario.

As part of an autonomous vehicle testing platform, graphical user interface (GUI) may be provided, in which the sequence of scenes is visualized (e.g. by displaying the scenes as a moving video image, or displaying a visualization of the detections), along with a timeline of hardness scores. In addition, a timeline of driving performance results may be displayed, enabling an expert uses to identify any correlation between the contents of the scenes, the hardness scores, and driving performance.

We refer to our co-pending International Patent Publication Nos. WO2022258660 and WO2022258671, each of which is incorporated herein by reference in its entirety. Therein, a visual user interface tool in the form of a ‘perception error timeline’ is described in respect of a time sequence of detections. That tool uses offline ground truth as a baseline to detect and visualize perception errors. The present techniques can be utilized in that context, to alternatively populate a perception error timeline (with overall perception performance scores, such as hardness scores) without requiring ground truth annotations. For example, the techniques could be used to mark ‘hard’ images or inputs on a visual timeline associated with a real-world driving scenario.

The time series of numerical perception scores may be a time series of hardness scores indicating a measure of difficulty for the perception system at each time step.

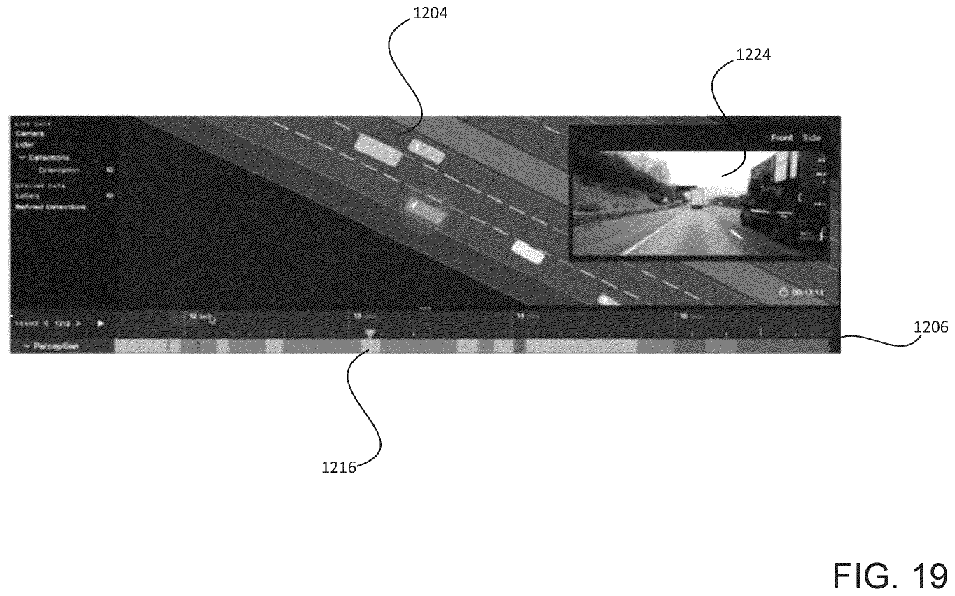

FIG. 19 shows an example user interface for analysing a driving scenario extracted from real-world data. An overhead schematic representation 1204 of a scene within the time sequence is shown, e.g., based on point cloud data (e.g. lidar, radar, or derived from stereo or mono depth imaging) with a corresponding camera frames 1224 shown in an inset. Road layout information displayed in the overed view 1204 may be obtained from high-definition map data. Camera frames 1224 may also be annotated with detections. The UI may also show sensor data collected during driving, such as lidar, radar or camera data. The scene visualisation 1204 is also overlaid with annotations based on the derived pseudo ground truth as well as the detections from the on-board perception components. In the example shown there are three vehicles, each annotated by a detected box generated by the perception component 102.

The UI 500 allows playback of the selected footage and a timeline view is shown where a user can select any point in the footage to show a snapshot of the bird's eye view and camera frames corresponding to the selected point in time.

A timeline 1206 of hardness scores is shown, which indicates the hardness of the scenes of the sequence at different points in time. A user may select a given point in time by moving a marker 1216 along the timeline 1206. In this manner, a user can visually correlate scene changes with relative hardness.

### Comparison of Hardness Definitions

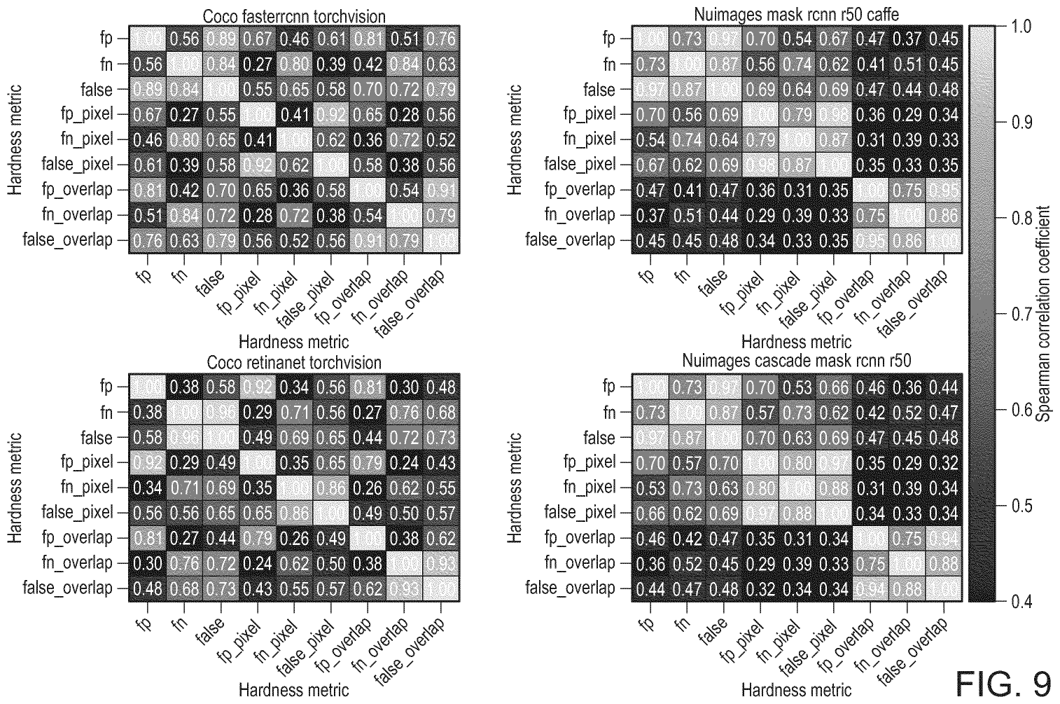

In FIG. 9, correlation between the proposed hardness measures on the kitti and coco datasets for faster rcnn and retinanet detectors is demonstrated. We observe that in general hardness measures may differ greatly in their ranking of the images in a dataset (i.e., false positive and false negative based metrics), although there are some similarities, e.g. hardness definitions which are reweighted versions of another hardness definition.

### The Role of NMS

Typically, the set of instances output by the detector are not the objects that are trained on. In the case of RetinaNet, a categorical cross-entropy loss is computed directly against the logits on the anchors. In the case of FasterRCNN, loss is computed in two parts; as a binary cross-entropy loss against the RPN's anchor objectness scores and a loss for each of the proposals produced by the RPN. At inference time, non-maximal suppression (NMS) is used to filter the sets of detections to a set of proposal instances.

If the detections y are pruned based on the score s being above a certain threshold e.g., before an NMS stage of the detector, then low likelihood bounding boxes, i.e. those with s tending towards zero will never appear in the sampled boxes. This means that the number of false positives in the samples from the stochastic model will be lower than it otherwise would have been if the raw, pre-NMS boxes were sampled from. In addition, this effect will increase the false negative rate. The NMS itself will also reduce the number of false positives, but this is unlikely to result in poor calibration of the sampled metrics because boxes with large IOU are not expected to appear in the annotations.

### Experiments

In this section, we illustrate the effectiveness of our approach in a variety of settings. The following assumes a specific detector D_{η} at a given score threshold η but we generally omit references to it for ease of notation. Given a dataset

$$𝒟 = {\{ {x}_{i} \}}_{i = 1}^{k} ,$$

we denote by ŝᵢ the ground-truth hardness score obtained using qₓ_{ᵢ}(yᵢ, ŷᵢ), where ŷ is the set ground-truth bounding boxes. For any given method and hardness measure, let us denote by sᵢ the hardness score corresponding to the i-th image. In the case of score-sampling, it is the expectation [symbol] \tilde{y}˜P(\tilde{y})[qₓ_{ᵢ}(ŷᵢ; \tilde{y}ᵢ)] defined in Eq. 5, while for the baselines, it is either the entropy or the DS measure directly.

### Datasets and Detectors

To illustrate the generality of our method, we only evaluate off-the-shelf models and on public-domain datasets for which weights are readily available. We perform our evaluations on the coco dataset [16] and nuimages [4] and consider the following detectors:
coco-retina and coco-rcnn are RetinaNet [15] and Faster-RCNN [18] with a ResNet-50-FPN backbone trained on the COCO dataset (from [17]).
mmdet-maskrcnn and mmdet-cascade are Mask-RCNN [11] and Cascade Mask-RCNN [5] with a ResNet-50-FPN backbone trained on nuimages (from [6, 1]). We dismiss all instance masks in our experiments are and only consider the bounding boxes. We remap the nuScenes and MMDetection label schemas to a simplified two class schema (just pedestrian and vehicle classes) that enables a more salient evaluation for the purposes of autonomous driving.

### Mapping of Classes Between Datasets

We remap the mmdet nuimages class labels to a coarser classification which only distinguishes between pedestrians and vehicles. This enables a more salient evaluation of the ability of a detector to identify and distinguish between objects in a way that is important for autonomous driving. It also means that we can compare with other AV datasets such as KITTI. Objects which cannot be remapped to vehicles or pedestrians are discarded. The class mapping is shown Table 2.

TABLE 2
Class remapping from nuimages mmdet
schema to simplified schema

| Original class | Remapped class |
|---|---|
| car | Vehicle |
| truck | Vehicle |
| trailer | Vehicle |
| bus | Vehicle |
| construction vehicle | Vehicle |
| bicycle | Vehicle |
| motorcycle | Vehicle |
| pedestrian | Pedestrian |
| traffic cone | None |
| barrier | None |

We set the pre-NMS score threshold to η=0.05 for all detectors. We perform our evaluations on the test set of the COCO and nulmages datasets.

### Hardness Measures

We use the weighted performance measures but our evaluation protocol can be easily extended to any single-image measure of performance. More precisely, we will consider all combinations of the counting, pixel-adjusted, and occlusion-aware hardness measures applied to the error categories fp, fn, and false=fp∪fn, giving us 9 hardness measures in total.

### Baselines

We consider entropy and Dempster-Shafer uncertainty estimates as our baselines. Both methods measure the uncertainty associated with an image using a categorical distribution over all possible classes for each detected box. For two-stage architectures (Faster-RCNN, Mask-RCNN, and Cascade-RCNN), each box is assigned a set of K+1 logits [symbol] (including the background class) which are then normalised to a categorical distribution with probabilities pᵢ by using a softmax. In this case, we use Eq. (1) and (2) directly with K being the total number of classes. The situation is different for RetinaNet, in which each box gets instead K+1 independent scores pᵢ∈[0, 1], representing the one-vs-all probability for that class (with associated logits [symbol] =logit(pᵢ)). It is not clear in this case how to define a predictive categorical distribution over all classes and we instead treat this situation as a binary problem and compute the uncertainty estimates for the maximum score p₁=maxᵢ(pᵢ) only, such that we set K=2 and p2=1−p1.

### Implementation Details

All of the performance measures are calculated using the implementation in pycocotools [16], including the association step. We compute our proposed ranking using score sampling (Algorithm 1) using 10 Monte Carlo samples in all experiments. This provides a favourable balance between accuracy and computational expense, as can be seen in a sensitivity analysis.

### Sensitivity to Number of Samples

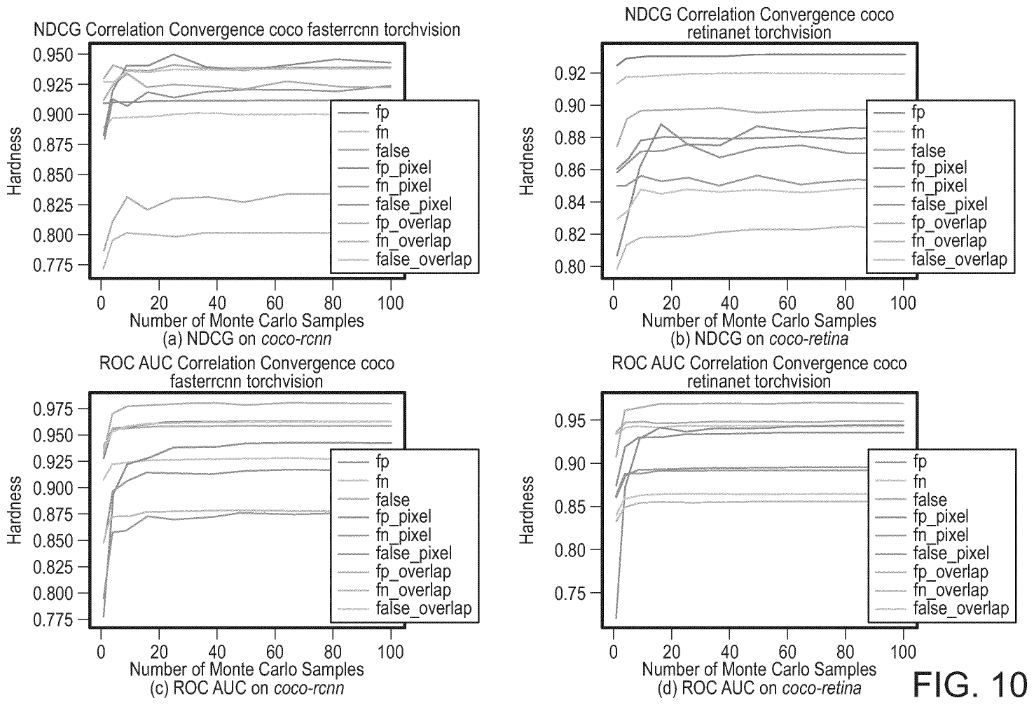

FIG. 10 shows how the evaluation metrics for the ranking change with respect to the number of Monte Carlo score samples. For a particular image the error in the expected hardness due to Monte Carlo approximation will decrease as

$$\frac{1}{\sqrt{N}} ,$$

where N is the number of Monte Carlo samples, since the formula for standard error in the mean is well known. We see that for most metrics the evaluation metric stabilises after about 10 Monte Carlo samples, and hence we consider this an appropriate number of samples to use for our evaluation in the experiments, to balance speed and efficacy.

### Qualitative Results

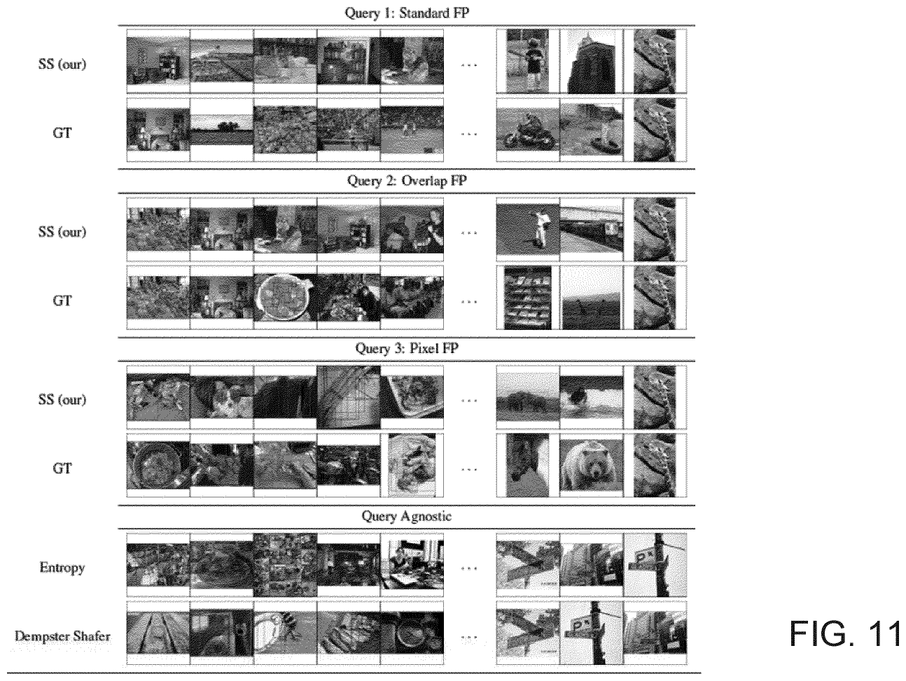

We first study qualitatively the efficacy of our method by searching for the 5 hardest and 3 easiest images for a variety of hardness queries for coco-rcnn, and then compare these with the actual hardest images obtained using the ground-truth boxes. These results are presented for the error category fp in FIG. 11. We display for each image the set of true positive, false positive, and false negative bounding boxes (in green, red, and blue, respectively) in order to allow for visual inspection of the performance of the detector. In FIG. 11, the hardest images are shown on the left and the easiest images on the right for the coco-rcnn. The bounding box colours are the same as for FIG. 6.

Contrary to entropy and evidential deep learning, our method is able to successfully identify images that have the expected error characteristics for a given query. For example, in the case of the query Total(fp) which asks for the images that are likely to have the most number of false positives, our method finds images featuring a large number of objects (such as books on a shelf, parked cars, etc) many of them being false positives. This is qualitatively similar to the images ranked using the ground-truth. The same is true for the PixelAdj(fp) and OccAware(fp) queries, where our method finds images that have large false-positive detections and many overlap-ping boxes, respectively. It is worth noting that in the case of OccAware(fp), our method guessed the top two images correctly, and in the case of the overlap the top two images are predicted correctly. Contrary to our method, the images identified by the non-query-based baseline are not similar to any specific query and mainly seem to feature a large number of bounding boxes in the image. This can be explained by the fact that both of these methods measure the total uncertainty over all boxes, see Eq. (1) and Eq. (2).

The images ranked last in term of hardness are somewhat less interesting (besides the fact that coco-rcnn is a very good giraffe detector) as they all feature a low number of correctly classified boxes. It is worth noting that in the case of entropy of DS uncertainty measures, the lowest ranking images have no bounding boxes and get a score of zero. We repeat this analysis for mmdet-askrcnn.

### Hardest Images

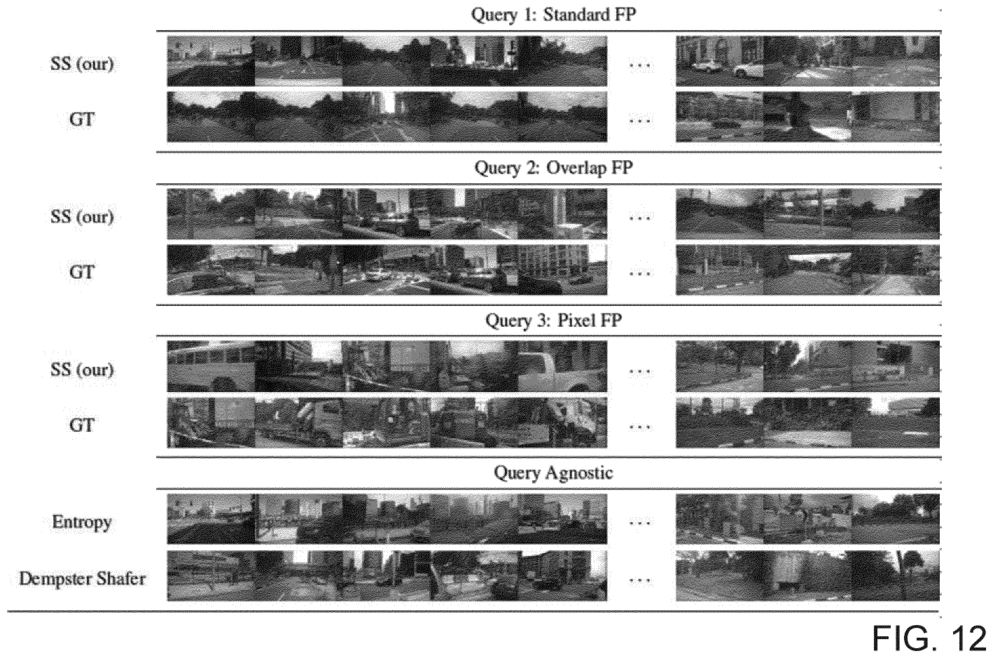

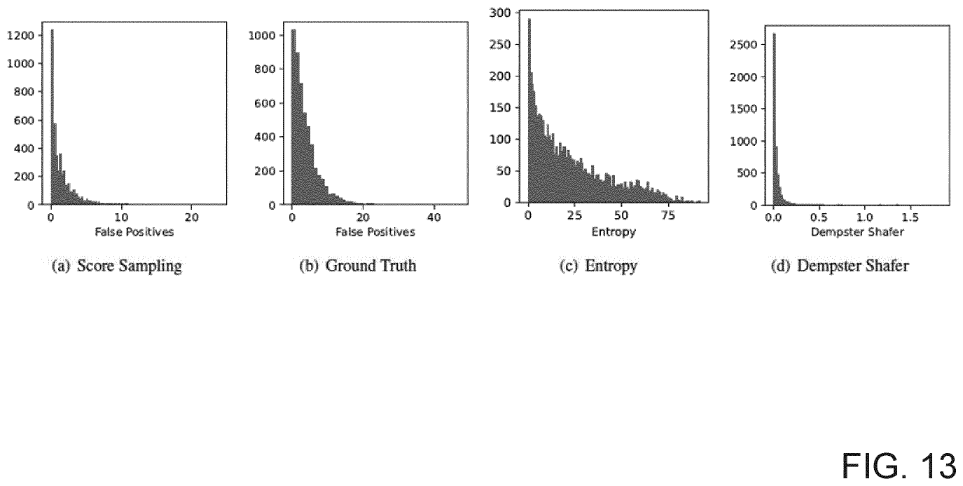

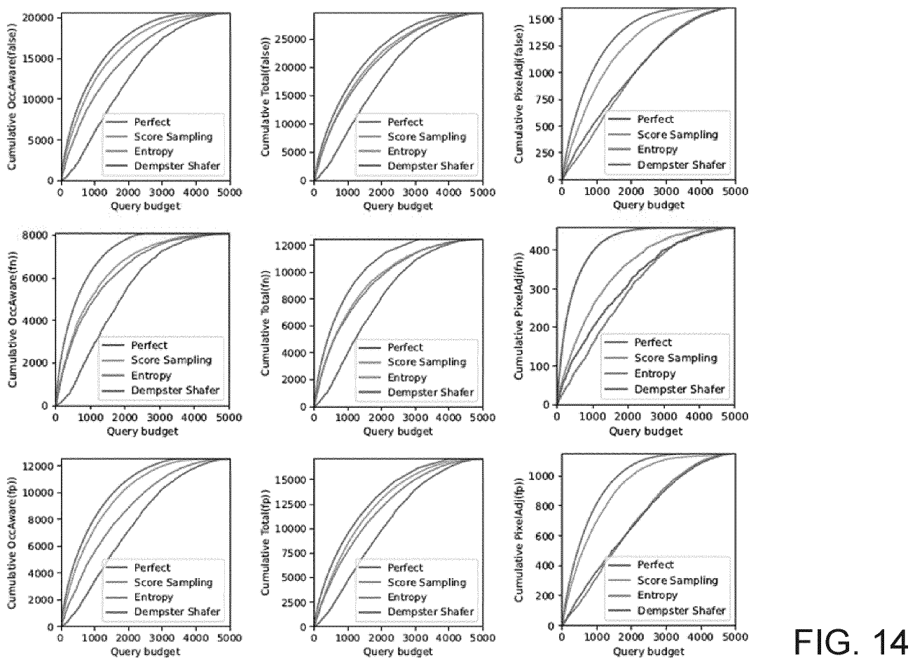

In FIG. 12 we repeat the analysis for mmdetmaskrcnn and show examples of the hardest images identified by the methods studied. The images found by score sampling often are more qualitatively similar to the true hardest images than those obtained from the baselines. FIG. 13 shows histograms for the estimated and actual number of false positives for coco-rcnn. Due to the large number of images with zero hardness there is no ranking for the easiest images, which should all be considered equally easy by this definition.

### Query-Based Hard-Image Ranking

We then evaluate more quantitatively the performance of our method at ranking images for a given hardness query. For any given method and hardness measure, we sort all images in the dataset in decreasing order of hardness scores sᵢ and compare the resulting ranking to the ground-truth ranking that is obtained by sorting images in decreasing order of ground-truth hardness ŝᵢ for that specific hardness measure. We evaluate ranking quality using the normalised discounted cumulative gain (nDCG) which is a well-known metric for ranking-based tasks (see for example [12]). The discounted cumulative gain can be defined as follows:

$$DCG = {\sum }_{i} \frac{{〈 {\hat{s}}_{j} 〉}_{j , {s}_{j} = {s}_{i}}}{{log}_{2} ( rank ( {x}_{i} ; 𝒟 ) + 1 )} , \qquad ( 6 )$$

where rank(xᵢ; [symbol] ) is the rank of image i when the dataset [symbol] is sorted in decreasing order of hardness score sᵢ, and [symbol] ŝⱼ [symbol] _{j,s}_{ⱼ}₌ₛ_{ᵢ} is the average ground-truth hardness of all images Xⱼ that have the same hardness score as Xᵢ, i.e. for which sⱼ=sᵢ. This ensures that the DCG is independent under re-orderings of images with the same hardness score. The normalised DCG is then defined by dividing the gain by the idealised gain as nDCG=DCG/DCG_{gt}, where DCG_{gt} is the DCG of the ground-truth ranking, see e.g. [12].

Ranking performance our method measured using the nDCG is shown on Table 3.

TABLE 3
Ranking performance of Score sampling (SS), score entropy (SE) and
evidential deep learning (Ev.) measured by the Normalised Discounted
Cumulative Gain (nDCG) against the ground truth ranking for a variety
of hardness queries. Larger is better for all metrics. Best methodology
for each hardness query is shown in bold.

| | SE | Ev. | SS (our) | SE | Ev. | SS (our) |
|---|---|---|---|---|---|---|
| | Normalised DCG | | | Normalised DCG | | |
| Hardness query | coco-retina | | | mmdet-maskrcnn | | |
| standard fp | 0.81 | 0.81 | 0.88 | 0.94 | 0.91 | 0.96 |
| standard fn | 0.91 | 0.92 | 0.92 | 0.91 | 0.88 | 0.90 |
| standard false | 0.92 | 0.92 | 0.93 | 0.94 | 0.91 | 0.95 |
| pixel fp | 0.66 | 0.66 | 0.87 | 0.72 | 0.75 | 0.90 |
| pixel fn | 0.74 | 0.74 | 0.85 | 0.68 | 0.72 | 0.89 |
| pixel false | 0.76 | 0.76 | 0.87 | 0.71 | 0.75 | 0.92 |
| overlap fp | 0.75 | 0.75 | 0.91 | 0.85 | 0.81 | 0.90 |
| overlap fn | 0.81 | 0.81 | 0.88 | 0.79 | 0.75 | 0.82 |
| overlap false | 0.82 | 0.83 | 0.91 | 0.85 | 0.81 | 0.89 |
| | coco-rcnn | | | mmdet-cascade | | |
| standard fp | 0.90 | 0.81 | 0.91 | 0.94 | 0.90 | 0.96 |
| standard fn | 0.90 | 0.77 | 0.90 | 0.91 | 0.88 | 0.90 |
| standard false | 0.94 | 0.83 | 0.94 | 0.94 | 0.91 | 0.95 |
| pixel fp | 0.79 | 0.80 | 0.93 | 0.70 | 0.72 | 0.91 |
| pixel fn | 0.72 | 0.77 | 0.82 | 0.68 | 0.71 | 0.88 |
| pixel false | 0.81 | 0.84 | 0.91 | 0.70 | 0.73 | 0.91 |
| overlap fp | 0.85 | 0.77 | 0.94 | 0.82 | 0.80 | 0.88 |
| overlap fn | 0.83 | 0.70 | 0.86 | 0.78 | 0.75 | 0.82 |
| overlap false | 0.88 | 0.78 | 0.94 | 0.83 | 0.81 | 0.88 |

We observe that in practically all cases score sampling matches or exceeds the performance of the baseline techniques, usually by a substantial margin. This is especially stark for the pixel-weighted and overlap-adjusted measures of hardness, which are not captured well by general purpose hardness estimation techniques. Similarly to what was observed in, we would like to emphasise that since existing metrics do not allow query-based hardness computation, therefore, we do not expect these techniques to perform well on the pixel and occlusion hardness measures since they remain the same irrespective of the hardness definition. Note that even though the ranking of score entropy and DS measure does not change, the ground truth ranking does such that their performance on different measures of hardness are different. The gap between methods is much smaller in the case of the Total queries which indicates that entropy and DS measures of uncertainty are a good proxy for finding the total number of errors in an image. In particular, entropy outperforms our method slightly for the query Total(fn) which could be due to the fact that the detectors are not perfectly calibrated. Finally, it is interesting to observe that Entropy for coco-retina performs relatively similarly to entropy for coco-rcnn, which is surprising as coco-rcnn provides a K-class distribution, which coco-retina does not.

Another way to visualise ranking performance is consider the cumulative ground-truth hardness of all the images queried with a certain query budget. This allows to easily visualise how quickly hard images can be found within a dataset. We show this results for Pixel(false) and coco-rcnn and see that score sampling finds these hard boxes much quicker than the baselines. We note that entropy and Dempster-Shafer barely perform better than a random ranking, which would be displayed as a diagonal line through the origin. We also note that a relatively large number of images are easy, and most of the hardness is contained in relatively few images. We display similar figures for other detectors, datasets and hardness definitions.

### Cumulative Hardness by Query Budget

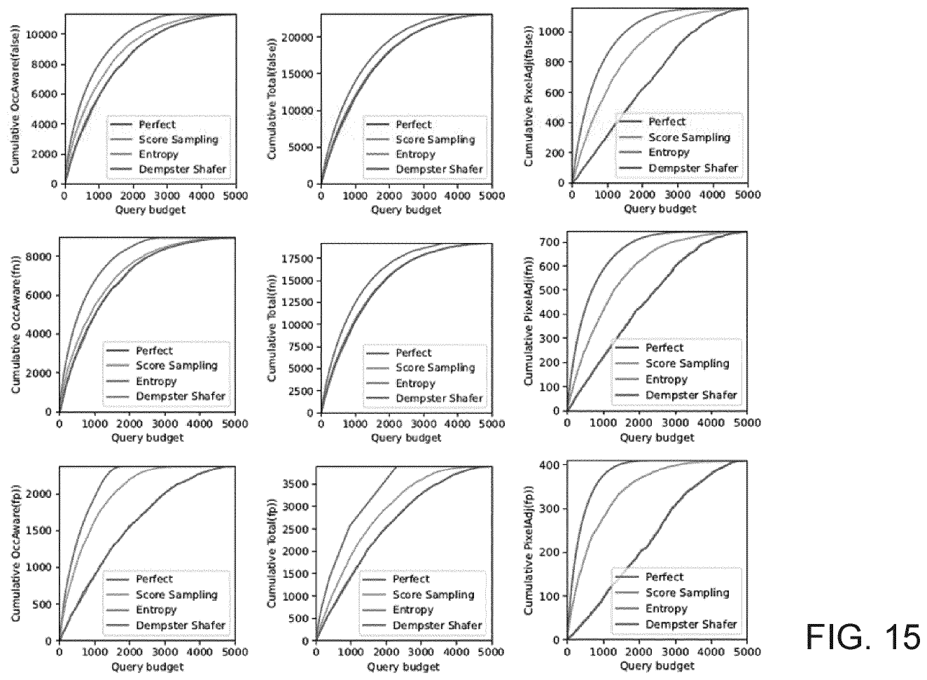

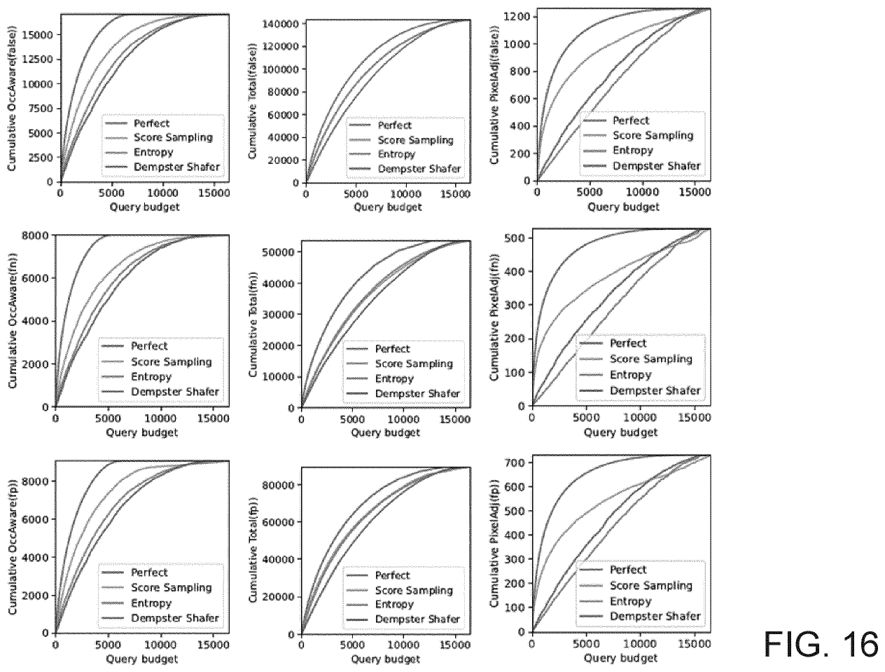

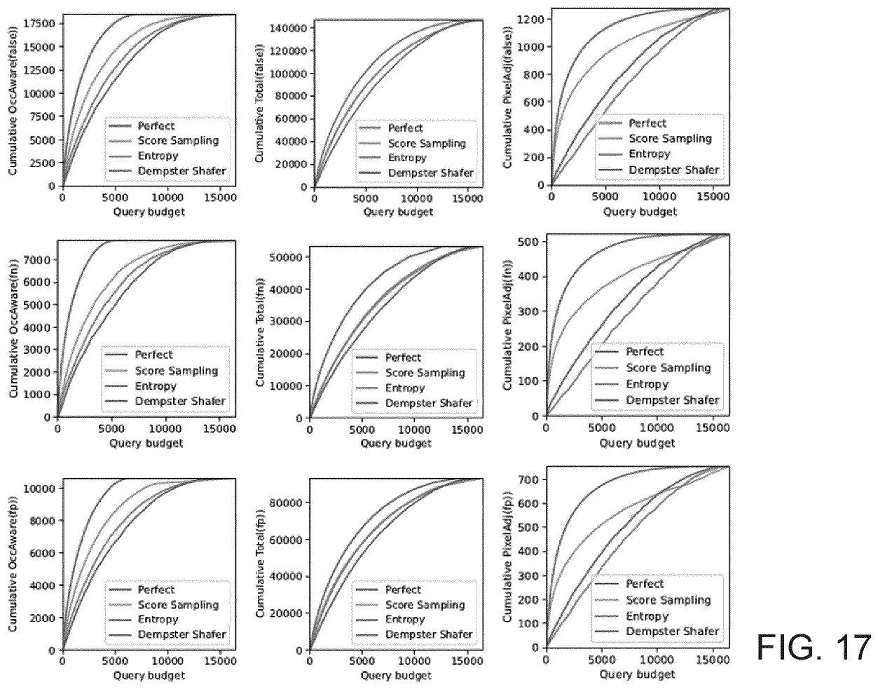

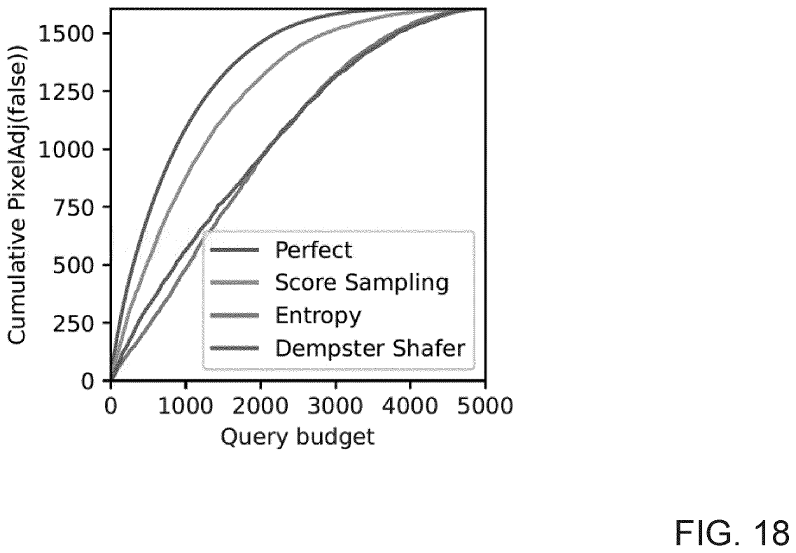

In FIGS. 14-17, we show the cumulative ground-truth hardness for various hardness definitions for various detectors and see that score sampling finds these hard boxes much quicker than the baselines. FIG. 18 shows Cumulative ground-truth hardness of false=fp∪fn boxes in images obtained with a fixed query budget for the pixel-adjusted hardness query. Perfect denotes queries done in descending order of ground-truth hardness.

### Query-Based Hard-Image Classification

We then consider the task of finding hard images within a dataset for a specific query. Given a definition of hardness, we define an image to be “hard” if its ground-truth hardness ŝᵢ is above a chosen threshold t_{hard} and “easy” otherwise. This effectively assigns a binary class label to each image and we evaluate the performance of our method at solving this hard vs. easy classification task. To do so, we construct a binary classifier by introducing a hardness score thresh-old score, and classify an image as “hard” if sᵢ>t_{score} and “easy” otherwise. Performance of this binary classifier can be evaluated using typical metrics for binary classification, such as ROC and AP, across all possible score thresholds t_{score}. If needed, a score threshold with a given application-specific trade-off of precision and recall can be easily obtained using a held-out dataset.

We evaluate our method and baselines across different hard vs. easy image ratios by choosing the hardness threshold thard such that this ratio is 5%, 10%, 25%, and 50% for each dataset. We present the mean ROC (mROC) over these threshold choices on Table 4.

TABLE 4
Comparing receiver operating curve (ROC) area under curve scores
for binary hardness metrics estimated using score sampling
(SS), evidential deep learning (Ev.) and score entropy (SE).
Best methodology for each hardness measure is shown in bold.

| | SE | Ev. | SS (our) | SE | Ev. | SS (our) |
|---|---|---|---|---|---|---|
| | mROC | | | mROC | | |
| Hardness query | coco-retina | | | mmdet-maskrcnn | | |
| standard fp | 0.77 | 0.78 | 0.88 | 0.90 | 0.83 | 0.91 |
| standard fn | 0.92 | 0.92 | 0.93 | 0.84 | 0.77 | 0.83 |
| standard false | 0.92 | 0.93 | 0.93 | 0.90 | 0.83 | 0.90 |
| pixel fp | 0.62 | 0.62 | 0.86 | 0.68 | 0.72 | 0.80 |
| pixel fn | 0.68 | 0.68 | 0.87 | 0.64 | 0.69 | 0.79 |
| pixel false | 0.66 | 0.66 | 0.88 | 0.66 | 0.71 | 0.85 |
| overlap fp | 0.72 | 0.72 | 0.93 | 0.83 | 0.80 | 0.90 |
| overlap fn | 0.86 | 0.86 | 0.90 | 0.81 | 0.77 | 0.85 |
| overlap false | 0.85 | 0.86 | 0.92 | 0.83 | 0.80 | 0.90 |
| | coco-rcnn | | | mmdet-cascade | | |
| standard fp | 0.90 | 0.73 | 0.94 | 0.90 | 0.82 | 0.91 |
| standard fn | 0.89 | 0.75 | 0.90 | 0.85 | 0.77 | 0.83 |
| standard false | 0.93 | 0.75 | 0.95 | 0.90 | 0.82 | 0.90 |
| pixel fp | 0.67 | 0.68 | 0.93 | 0.66 | 0.69 | 0.80 |
| pixel fn | 0.73 | 0.75 | 0.81 | 0.63 | 0.67 | 0.77 |
| pixel false | 0.70 | 0.72 | 0.91 | 0.65 | 0.69 | 0.83 |
| overlap fp | 0.84 | 0.70 | 0.95 | 0.82 | 0.79 | 0.89 |
| overlap fn | 0.87 | 0.72 | 0.89 | 0.80 | 0.78 | 0.85 |
| overlap false | 0.88 | 0.72 | 0.95 | 0.83 | 0.80 | 0.89 |

In most cases, score sampling exceeds or matches the performance of the baseline techniques. Again, we observe score sampling performs better for hardness definitions which measure a specific property of the detection error.

The described approach enables the finding and ranking of hard images from an unlabelled dataset. It is demonstrated that it is possible to construct a Monte Carlo approximation for hardness definitions, obtained by sampling from a simple but effective stochastic model for ground truth obtained from object detector instance scores. We provided extensive analysis to show that such approximations rank and find hard images more effectively than general purpose image hardness estimation techniques, whilst also being entirely post-hoc by not requiring modification or specific training of the object detector. More complex and accurate stochastic models could be employed to provide an improved ranking and a study into the absolute accuracy of the estimation of the image hardness could be conducted, e.g. using test time calibrated object detectors and other uncertainty estimation techniques such as deep ensemble object detectors. In addition, the efficacy of this technique on out of domain unlabelled images could be studied.

### REFERENCES

Each of the following is incorporated herein by reference in its entirety:
[1] mmdetection3d/configs/nuimages openmmlab/mmdetection3d 2022, 2022.
[2] Hamed H Aghdam, Abel Gonzalez-Garcia, Joost van de Weijer, and Antonio M L′opez. Active learning for deep detection neural networks. In Proceedings of the IEEE/CVF International Conference on Computer Vision, pages 3672-3680. openaccess.thecvf.com, 2019.
[3] Maxime Bucher, Stephane Herbin, and Fr′ed′eric Jurie. Hard negative mining for metric learning based Zero-Shot classification. In Computer Vision—ECCV 2016 Workshops, pages 524-531. Springer International Publishing, 2016.
[4] Holger Caesar, Varun Bankiti, Alex H. Lang, Sourabh Vora, Venice Erin Liong, Qiang Xu, Anush Krishnan, Yu Pan, Giancarlo Baldan, and Oscar Beijbom. nuscenes: A multimodal dataset for autonomous driving. arXiv preprint arXiv: 1903.11027, 2019.
[5] Zhaowei Cai and Nuno Vasconcelos. Cascade r-cnn: high quality object detection and instance segmentation. IEEE transactions on pattern analysis and machine intelligence, 43 (5): 1483-1498, 2019.
[6] Kai Chen, Jiaqi Wang, Jiangmiao Pang, Yuhang Cao, Yu Xiong, Xiaoxiao Li, Shuyang Sun, Wansen Feng, Ziwei Liu, Jiarui Xu, et al. Mmdetection: Open mmlab detection toolbox and benchmark. arXiv preprint arXiv: 1906.07155, 2019.
[7] Jiwoong Choi, Ismail Elezi, Hyuk-Jae Lee, Clement Farabet, and Jose M Alvarez. Active learning for deep object detection via probabilistic modeling. March 2021.
[8] Di Feng, Xiao Wei, Lars Rosenbaum, Atsuto Maki, and Klaus Dietmayer. Deep active learning for efficient training of a LiDAR 3D object detector. January 2019.
[9] David A Forsyth and Jean Ponce. Computer vision: a modern approach. Pearson, 2012.
[10] Elmar Haussmann, Michele Fenzi, Kashyap Chitta, Jan Ivanecky, Hanson Xu, Donna Roy, Akshita Mittel, Nicolas Koumchatzky, Clement Farabet, and Jose M Alvarez. Scalable active learning for object detection. April 2020.
[11] Kaiming He, Georgia Gkioxari, Piotr Doll′ar, and Ross Girshick. Mask r-cnn. In Proceedings of the IEEE international conference on computer vision, pages 2961-2969, 2017.
[12] Kalervo J″arvelin and Jaana Kek “al” ainen. Cumulated gainbased evaluation of ir techniques. ACM Transactions on Information Systems (TOIS), 20 (4): 422-446, 2002.
[13] Souyoung Jin, Aruni RoyChowdhury, Huaizu Jiang, Ashish Singh, Aditya Prasad, Deep Chakraborty, and Erik Learned-Miller. Unsupervised hard example mining from videos for improved object detection. In Proceedings of the European Conference on Computer Vision (ECCV), pages 307-324. openaccess.thecvf.com, 2018.
[14] Suraj Kothawade, Donna Roy, Michele Fenzi, Elmar Haussmann, Jose M Alvarez, and Christoph Angerer. Objectlevel targeted selection via deep template matching. In Machine Learning for Autonomous Driving Workshop at the 35th Conference on Neural Information Processing Systems (NeurIPS 2021), 2021.
[15] Tsung-Yi Lin, Priya Goyal, Ross Girshick, Kaiming He, and Piotr Doll′ar. Focal loss for dense object detection. In Proceedings of the IEEE international conference on computer vision, pages 2980-2988. openaccess.thecvf.com, 2017.
[16] Tsung-Yi Lin, Michael Maire, Serge Belongie, James Hays, Pietro Perona, Deva Ramanan, Piotr Doll′ar, and C Lawrence Zitnick. Microsoft coco: Common objects in context. In European conference on computer vision, pages 740-755. Springer, 2014.
[17] Adam Paszke, Sam Gross, Francisco Massa, Adam Lerer, James Bradbury, Gregory Chanan, Trevor Killeen, Zeming Lin, Natalia Gimelshein, Luca Antiga, et al. Pytorch: An imperative style, high-performance deep learning library. Advances in neural information processing systems, 32, 2019.
[18] Shaoqing Ren, Kaiming He, Ross Girshick, and Jian Sun. Faster r-cnn: Towards real-time object detection with region proposal networks. Advances in neural information processing systems, 28, 2015.
[19] Soumya Roy, Asim Unmesh, and Vinay P Namboodiri. Deep active learning for object detection. In BMVC, volume 362, page 91. bmva.org, 2018.
[20] Murat Sensoy, Lance Kaplan, and Melih Kandemir. Evidential deep learning to quantify classification uncertainty. Advances in Neural Information Processing Systems, 31, 2018.
[21] Abhinav Shrivastava, Abhinav Gupta, and Ross Girshick. Training region-based object detectors with online hard example mining. In Proceedings of the IEEE conference on computer vision and pattern recognition, pages 761-769. cvfoundation.org, 2016.
[22] Yumin Suh, Bohyung Han, Wonsik Kim, and Kyoung Mu Lee. Stochastic class-based hard example mining for deep metric learning. In Proceedings of the IEEE/CVF Conference on Computer Vision and Pattern Recognition, pages 7251-7259. openaccess.thecvf.com, 2019.
[23] Tianyu Tang, Shilin Zhou, Zhipeng Deng, Huanxin Zou, and Lin Lei. Vehicle detection in aerial images based on region convolutional neural networks and hard negative example mining. Sensors, 17 (2), February 2017.
[24] Hao Yu, Zhaoning Zhang, Zheng Qin, Hao Wu, Dongsheng Li, Jun Zhao, and Xicheng Lu. Loss rank mining: A general hard example mining method for real-time detectors. In 2018 International Joint Conference on Neural Networks (IJCNN), pages 1-8. ieeexplore.ieee.org, July 2018.
[25] Weiping Yu, Sijie Zhu, Taojiannan Yang, Chen Chen, and Mengyuan Liu. Consistency-based active learning for object detection. March 2021.

1. A computer-implemented method of assessing performance of perception component, the perception component for interpreting structure in a scene, the method comprising:
receiving a set of multiple computed outputs obtained by applying the perception component to the scene, wherein each computed output comprises a confidence score;
generating, from the set of multiple computed outputs, multiple pseudo-ground truth sets, wherein each pseudo-ground truth set comprises, for each computed output, a pseudo-ground truth output sampled from a set of possible ground truth outputs based on a probability distribution defined by the confidence score of the computed output;
computing a performance score for the perception component applied to the scene with respect to each pseudo-ground truth set, by comparing the set of multiple outputs with that pseudo-ground truth set; and
computing an overall performance score for the perception component applied to the scene, by aggregating the performance scores computed with respect to the multiple pseudo-ground truth sets.

2. The method of claim 1, wherein the perception component is an object detector and wherein the set of multiple computed outputs is a set of object detections.

3. The method of claim 2, wherein each pseudo-ground truth output comprises either a positive existence indicator or a negative existence indicator, wherein the performance score for each pseudo-ground truth set is a perception hardness score, evaluated based on one or both of false positive detections and false negative detections with respect to that pseudo-ground truth set, wherein false positive detections are object detections whose confidence scores satisfy a minimum confidence threshold but which have a negative existence indicator in that pseudo-ground truth set, wherein false negative detections are object detections whose confidence scores do not satisfy the minimum confidence threshold but which have a positive existence indicator of that pseudo-ground truth set.

4. The method of claim 3, wherein each object detection defines an object location and an object extent.

5. The method of claim 2, wherein each object detection defines an object location and an object extent, and wherein each pseudo-ground truth output comprises either a positive existence indicator or a negative existence indicator, the method comprising:
for each pseudo-ground truth set:
generating for each positive existence indicator, a pseudo-ground truth object that defines an object location and object extent, and
attempting to associate each object detection with a pseudo-ground truth object based on relative intersection therebetween:
wherein the performance score for each pseudo-ground truth set is a perception hardness score, evaluated based on one or both of false positive detections and false negative detections with respect to that pseudo-ground truth set, wherein false positive detections are object detections whose confidence scores satisfy a minimum confidence threshold but which are not successfully associated with any pseudo-ground truth object of that pseudo-ground truth set, wherein false negative detections are object detections whose confidence scores do not satisfy the minimum confidence threshold but which have been successfully associated with a pseudo-ground truth object of that pseudo-ground truth set.

6. The method of claim 3, wherein the performance score for each pseudo-ground truth set is:
a count of false positive detections for that pseudo-ground truth set,
a count of false negative detections for that pseudo-ground truth set, or
a count of both false positive and false negative detections for that pseudo-ground truth set.

7. The method of claim 4, wherein computing the performance score for each pseudo-ground truth set comprises computing, for each object detection of an error set, a weighted error, which is an object size as a fraction of a size of the scene, wherein the performance score is computed by summing the weighted errors, and wherein the error set consists of all false positive detections for that pseudo-ground truth set, all false negative detections for that pseudo-ground truth set, or all false positive detections and all false negative detections for that pseudo-ground truth set.

8. The method of claim 7, wherein the scene is a 2D image, wherein each object detection comprises a 2D bounding object defining the object location and the object extent, and wherein the performance score is computed as:
$${PixelAdj}_{x} ( e ( \tilde{y} , y ) ) = {\sum }_{b ∈ e ( \hat{y} , y )} \frac{area ( b )}{area ( x )} ,$$
where y denotes the pseudo-ground truth set, ŷ denotes the set of object detections, e(ŷ, y) denotes the error set, x denotes the scene, and b denotes a 2D bounding object.

9. The method of claim 4, wherein computing the performance score for each pseudo-ground truth object set comprises computing, for each object detection of an error set, an occlusion value, which is a measure of intersection between the object detection and any true positive detection as a fraction of object size, wherein the performance score is computed by summing the occlusion values, and wherein the error set consists of all false positive detections for that pseudo-ground truth set, all false negative detections for that pseudo-ground truth set, or all false positive detections and all false negative detections for that pseudo-ground truth set, true positives being detections whose confidence score satisfies the minimum confidence threshold and which have a positive existence indicator in that pseudo-ground truth set or which have been successfully associated with a pseudo-ground truth object of that pseudo-ground truth set.

10. The method of claim 9, wherein the scene is a 2D image, wherein each object detection comprises a 2D bounding object defining the object location and the object extent, and wherein the performance score is computed as:
$${OccAware}_{x} ( e ( \hat{y} , y ) ) = {\sum }_{\begin{matrix}b ∈ e ( \hat{y} , y ) \\ {b}^{′} ∈ tp ( x )\end{matrix}} \frac{inter ( b , {b}^{′} )}{area ( b )} ,$$
where y denotes the pseudo-ground truth set, ŷ denotes the set of object detections, e(ŷ, y) denotes the error set for the pseudo-ground truth object set y, x denotes the scene, b denotes a 2D bounding object, and tp(x) denotes the set of all true positives.

11. The method of claim 3, wherein each object detection comprises an object class, and the object detections are classified as false positive or false negatives with respect to a particular object class.

12. The method of claim 1, applied to multiple scenes to obtain respective overall performance scores for the multiple scenes, the method further comprising using the overall performance scores to identify and mitigate a performance issue in the perception component.

13. The method of claim 12, wherein the perception component is a trained machine learning component, mitigating the performance issue comprises re-training the perception component based on a subset of the multiple scenes selected based on their overall performance scores.

14. The method of claim 1, applied to a time-sequence of multiple scenes to obtain respective overall performance scores for the multiple scenes, the method further comprising generating a graphical user interface that comprises a timeline of the overall performance scores and a visualization of the multiple scenes.

15. The method of claim 1, wherein each object detection comprises a bounding box or other bounding object defining an object location and an object extent.

16. A non-transitory computer readable medium embodying computer program instructions, the computer program instructions configured so as, when executed on one or more hardware processors, to implement operations comprising:
receiving a set of object detections obtained by applying an object detector to a scene, each object detection including a confidence score;
generating, from the set of object detections, multiple pseudo-ground truth object sets, wherein each pseudo-ground truth object set comprises, for each object detection, an existence indicator assigned thereto, wherein the existence indicator is sampled from a set of existence indicators based on a probability distribution defined by the confidence score of the object detection;
for each pseudo-ground truth object set:
comparing the set of object detections with the pseudo-ground truth object set, to identify any discrepant object detections of the set of object detections, a discrepant object detection having:
a positive existence indicator in the pseudo-ground truth object set and a confidence score that does not satisfy a minimum confidence threshold, or
a negative existence indicator in the pseudo-ground truth object set and a confidence score that does satisfy the minimum confidence threshold, and
computing a performance score for the object detector applied to the scene with respect to that pseudo-ground truth object set based on the discrepant object detections; and
computing an overall performance score for the object detector applied to the scene, by aggregating the performance scores computed with respect to the multiple pseudo-ground truth object sets.

17. A computer system for assessing performance of an object detector on a scene, the computer system comprising:
at least one memory storing computer-readable instructions; and
at least one processor coupled to the at least one memory and configured to execute the computer-readable instructions, which upon execution cause the at least one processor to:
receive a set of multiple computed outputs obtained by applying a perception component to the scene, wherein each computed output comprises a confidence score;
generate, from the set of multiple computed outputs, multiple pseudo-ground truth sets, wherein each pseudo-ground truth set comprises, for each computed output, a pseudo-ground truth output sampled from a set of possible ground truth outputs based on a probability distribution defined by the confidence score of the computed output;
compute a performance score for the perception component applied to the scene with respect to each pseudo-ground truth set, by comparing the set of multiple outputs with that pseudo-ground truth set; and
compute an overall performance score for the perception component applied to the scene, by aggregating the performance scores computed with respect to the multiple pseudo-ground truth sets.

18. (canceled)

19. The computer system of claim 17, wherein the perception component is an object detector and wherein the set of multiple computed outputs is a set of object detections.

20. The computer system of claim 19, wherein each pseudo-ground truth output comprises either a positive existence indicator or a negative existence indicator, wherein the performance score for each pseudo-ground truth set is a perception hardness score, evaluated based on one or both of false positive detections and false negative detections with respect to that pseudo-ground truth set, wherein false positive detections are object detections whose confidence scores satisfy a minimum confidence threshold but which have a negative existence indicator in that pseudo-ground truth set, wherein false negative detections are object detections whose confidence scores do not satisfy the minimum confidence threshold but which have a positive existence indicator of that pseudo-ground truth set.

21. The computer system of claim 19, wherein each object detection defines an object location and an object extent.
